(19) United States
(12) Patent Application Publication
(10) Pub. No.: US 2018/0376131 A1
(43) Pub. Date: Dec. 27, 2018

(54) IMAGE PROCESSING APPARATUS, IMAGE PROCESSING SYSTEM, AND IMAGE PROCESSING METHOD

(71) Applicant: CANON KABUSHIKI KAISHA, Tokyo (JP)

(72) Inventor: Masahiro Handa, Tokyo (JP)

(21) Appl. No.: 16/012,629

(22) Filed: Jun. 19, 2018

(30) Foreign Application Priority Data
Jun. 21, 2017 (JP) 2017-121703

(51) Int. Cl. H04N 13/282; H04N 13/204; G06T 15/00

(52) U.S. Cl. CPC H04N 13/282; G06T 15/005; H04N 13/204

(57) ABSTRACT

In a case where image processing is performed by a plurality of image processing apparatuses, even if some of the plurality of image processing apparatuses cannot execute processing, adverse effects thereof can be reduced. An image processing apparatus determines whether to execute image processing based on additional information about an image acquired from another image processing apparatus.

### BACKGROUND

### Field of the Disclosure

The present disclosure relates to an image processing system that processes a plurality of images.

### Description of the Related Art

A technique of generating a virtual viewpoint content with arbitrarily changed viewpoints using multiple viewpoint images obtained by performing synchronous imaging from multiple viewpoints by a plurality of cameras installed in different positions is known. According to the technique of generating a virtual viewpoint content using multiple viewpoint images, it is possible to provide users with higher realistic sensation as compared with normal images in which viewpoints cannot be arbitrarily changed.

A virtual viewpoint content based on multiple viewpoint images is generated by collecting images captured by a plurality of cameras in an image processing unit, such as a server, generating a three-dimensional model, and performing processing such as rendering on the images, and the generated virtual viewpoint content is transmitted to a user terminal for browsing.

Japanese Patent Laid-Open No. 2014-215828 discusses a technique in which a plurality of cameras is disposed so as to surround an area and a virtual viewpoint image corresponding to arbitrary designation is generated and displayed using the captured image of the area.

In a system in which images captured by a plurality of cameras are accumulated in a server to generate a virtual viewpoint content, the processing load of the server increases. On the other hand, if at least a part of image processing for generating a virtual viewpoint content is performed by one or more other image processing apparatuses, the processing load can be distributed. In this case, however, if the plurality of apparatuses appropriately cooperates with each other for image processing, image processing may not be fully performed on images due to the virtual viewpoint content. For example, assume a case where image processing cannot be normally executed on images due to a breakdown or power failure of one of the plurality of apparatuses sharing image processing. In this case, even though the image processing is shared among the plurality of apparatuses and another one of the plurality of apparatuses acquires an image from the apparatus that cannot normally execute the image processing, necessary image processing cannot be executed if there is no mechanism for determining the execution of image processing on the obtained image. The generation of a virtual viewpoint content in a state where necessary image processing it not executed on the captured image used for generating the virtual viewpoint content may cause such problems that a part of the virtual viewpoint content may be omitted, the image quality may be lowered, or it may take a lot of time to generate virtual viewpoint images. Similar problems may be caused not only in the case of generating a virtual viewpoint content, but also in the case of generating an image, such as a panoramic image, by using images captured by a plurality of cameras.

### SUMMARY

According to an aspect of the present disclosure,

an image processing apparatus includes, a first acquisition unit configured to acquire, from a first another image processing apparatus, an image based on image capturing by a first imaging apparatus and additional information about the image, a second acquisition unit configured to acquire an image captured by a second imaging apparatus different from the first imaging apparatus, a determination unit configured to determine whether to execute predetermined image processing for generating a virtual viewpoint image, by using the image acquired by the first acquisition unit and the image acquired by the second acquisition unit based on the additional information acquired by the first acquisition unit, and a processing unit configured to execute the predetermined image processing in a case where the determination unit determines that the predetermined image processing is executed.

Further features of the present disclosure will become apparent from the following description of exemplary embodiments (with reference to the attached drawings).

### BRIEF DESCRIPTION OF THE DRAWINGS

FIG. 1 is a diagram illustrating a configuration of an image processing system 100.

FIG. 2 is a block diagram illustrating a functional configuration of a camera adapter 120.

FIG. 3 is a diagram illustrating a flow of data among camera adapters 120.

FIG. 4 is a diagram illustrating bypass transmission of the camera adapter 120.

FIG. 5 is a diagram illustrating a gazing point group.

FIG. 6 is a diagram illustrating a bypass transmission control of the camera adapter 120.

FIG. 7 is a diagram illustrating an example of a data format to be transferred among the camera adapters 120.

FIG. 8 is a flowchart illustrating a processing flow of the camera adapter 120.

FIG. 9 is a diagram illustrating a determination table for the camera adapter 120 to determine a content of processing on received data.

FIG. 10 is a diagram illustrating a processing sequence of the camera adapter 120.

FIG. 11 is a diagram illustrating a processing sequence of a plurality of camera adapters 120 when a camera adapter 120b is in a bypass control mode.

FIG. 12A is a diagram illustrating an example of format of output data from the camera adapter 120a. FIG. 12B is a diagram illustrating an example of format of output data from the camera adapter 120b. FIG. 12C is a diagram illustrating an example of format of output data from the camera adapter 120c.

FIG. 13A is a diagram illustrating an example of format of output data from the camera adapter 120a. FIG. 13B is a diagram illustrating an example of format of output data from the camera adapter 120b. FIG. 13C is a diagram illustrating an example of format of output data from the camera adapter 120c.

FIG. 14 is a flowchart illustrating a processing flow of the camera adapter 120.

FIG. 15 is a diagram illustrating a hardware configuration of each device of an image processing system.

### DESCRIPTION OF THE EMBODIMENTS

An exemplary embodiment that enables an image processing apparatus can determine whether to execute image processing on images transmitted in a system in which a plurality of images is processed by a plurality of image processing apparatuses will be described.

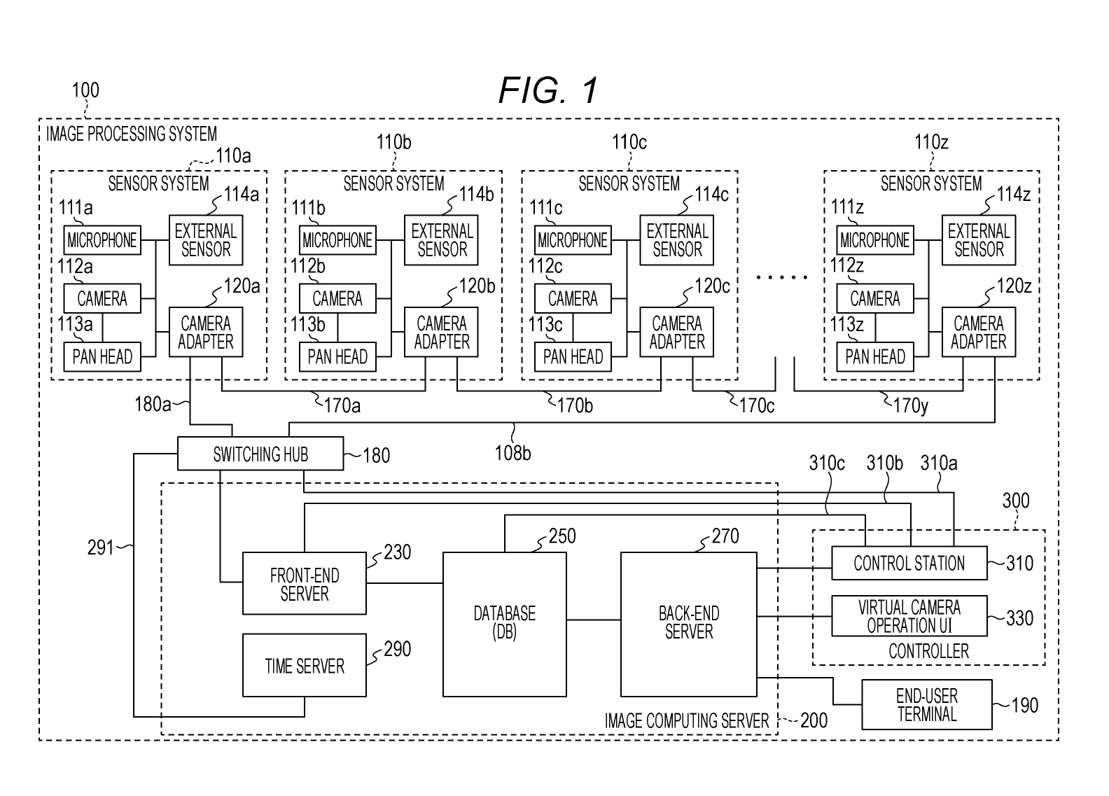

A system in which a plurality of cameras and a plurality of microphones are installed so as to capture images and collect sound in stadiums and concert halls will be described with reference to a diagram of a system configuration illustrated in FIG. 1. An image processing system 100 includes sensor systems 110a to 110z, an image computing server 200, a controller 300, a switching hub 180, and an end-user terminal 190.

The controller 300 includes a control station 310 and a virtual camera operation UI 330. The control station 310 performs management of operation states, control of a parameter setting, and the like on blocks included in the image processing system 100 through networks 310a to 310c, networks 180a and 180b, and networks 170a to 170y. The networks may be gigabit Ethernet® (GbE) or 10 GbE based on the IEEE standard which is the Ethernet or a combination of an interconnect Infiniband, an industrial Ethernet, and the like. The networks are not limited to these and other types of network may be employed.

An operation for transmitting 26 sets of images and audio of the sensor systems 110a to 110z from the sensor system 110z to the image computing server 200 will be described. In the image processing system 100 according to the present exemplary embodiment, the sensor systems 110a to 110z are connected to each other by a daisy chain.

In the present exemplary embodiment, the 26 sets of systems of the sensor systems 110a to 110z are not distinguished from each another and are collectively referred to as a sensor system 110 unless otherwise described. Similarly, devices included in each of the sensor systems 110 are not distinguished from each other and are collectively referred to as a microphone 111, a camera 112, a pan head 113, an external sensor 114, and a camera adapter 120, unless otherwise described. Although the 26 sets of sensor systems are illustrated as the number of sensor systems, the number is merely an example. The number of sensor systems is not limited to 26 sets.

In the present exemplary embodiment, the term “image” includes a concept of a moving image and a still image, unless otherwise noted. Specifically, the image processing system 100 according to the present exemplary embodiment is capable of processing both of still images and moving images. In the present exemplary embodiment, a case where a virtual viewpoint content provided by the image processing system 100 includes a virtual viewpoint image and virtual viewpoint audio is mainly described by way of example, but the present disclosure is not limited to this case. For example, the virtual viewpoint content may not include audio. For example, audio included in the virtual viewpoint content may be collected by a microphone positioned closest to a virtual viewpoint. Although the description of audio is partially omitted for simplicity of explanation in the present exemplary embodiment, an image and audio are basically processed at the same time.

The sensor systems 110a to 110z include cameras 112a to 112z, respectively. Specifically, the image processing system 100 includes a plurality of cameras 112 for capturing images of a subject from a plurality of directions. The plurality of sensor systems 110 is connected to each other by the daisy chain. With this connection form, effects of reducing the number of connection cables and reducing wiring works can be attained when the amount of image data is increased due to a high resolution and a high frame rate required for 4K, 8K, or the like of captured images.

The connection form is not limited to this and a star type network configuration in which the sensor systems 110a to 110z are each connected to the switching hub 180 and perform data transmission and reception through the switching hub 180 may be employed.

Although FIG. 1 illustrates a configuration in which all the sensor systems 110a to 110z are connected by cascade connection so that the daisy chain is configured, the connection form is not limited to this. For example, the plurality of sensor systems 110 may be divided into some groups and the sensor systems 110 may be connected by the daisy chain in each group obtained by the division. Then, the camera adapters 120 serving as terminals of the division units may be connected to the switching hub 180 so that images are input to the image computing server 200. Such a configuration is particularly effective in stadiums. For example, it is assumed that a stadium has a plurality of floors and the sensor systems 110 are installed in the respective floors. In this case, input to the image computing server 200 may be performed for each floor or for each half circumference of the stadium. Accordingly, installation of the sensor systems 110 may be simplified and the image processing system 100 can be made flexible even in a location where it is difficult to wire all the sensor systems 110 by one daisy chain.

Control of image processing to be performed by the image computing server 200 can be switched depending on a result of a determination as to whether the number of camera adapters 120 which are connected by the daisy chain and which input images to the image computing server 200 is one or two or more. Specifically, the control can be switched depending on a result of a determination as to whether the sensor systems 110 are divided into a plurality of groups. In a case where only one camera adapter 120 performs image input, an image of the entire circumference of the stadium is generated while image transmission is performed by the daisy chain connection, and thus timings when the image computing server 200 obtains image data on the entire circumference of the stadium are synchronized. Specifically, if the sensor systems 110 are not divided into groups, the image computing server 200 can synchronize the timings for obtaining image data on the entire circumference of the stadium without performing a special synchronization control.

However, in a case where a plurality of camera adapters 120 is used for image input (sensor systems 110 are divided into groups), different delays may occur in different lanes (paths) of the daisy chain. Therefore, in the image computing server 200, image processing needs to be performed in a subsequent stage while a mass of image data is checked by synchronization control in which synchronization is performed by waiting until image data on the entire circumference of the stadium is obtained.

In the present exemplary embodiment, the sensor system 110a includes a microphone 111a, a camera 112a, a pan head 113a, an external sensor 114a, and a camera adapter 120a. The configuration of the sensor system 110a is not limited to this configuration as long as the sensor system 110a includes at least one camera adapter 120a and one camera 112a or one microphone 111a. For example, the sensor system 110a may include one camera adapter 120a and a plurality of cameras 112a or include one camera 112a and a plurality of camera adapters 120a. Specifically, the plurality of cameras 112 and the plurality of camera adapters 120 included in the image processing system 100 have the relationship of a ratio of N:M (N and M are integers not less than 1). The sensor system 110 may include devices in addition to the microphone 111a, the camera 112a, the pan head 113a, and the camera adapter 120a. The camera 112 and the camera adapter 120 may be integrated with each other. Further, a front-end server 230 may have at least some of the functions of the camera adapter 120. Since the sensor systems 110b to 110z each have a configuration similar to that of the sensor system 110a in the present exemplary embodiment, the description of the configuration of each of the sensor systems 110b to 110z is omitted. The configuration of each of the sensor systems 110b to 110z is not limited to the configuration of the sensor system 110a and the sensor systems 110b to 110z may have different configurations.

The camera adapter 120 is a device that performs image processing. Audio collected by the microphone 111a and an image captured by the camera 112a are subjected to image processing as described below by the camera adapter 120a before being transmitted to the camera adapter 120b included in the sensor system 110b through the daisy chain 170a. Similarly, the sensor system 110b transmits collected audio and a captured image, in addition to the image and audio obtained from the sensor system 110a, to the sensor system 110c.

By continuously performing the operation described above, images and audio obtained by the sensor systems 110a to 110z are transmitted to the switching hub 180 from the sensor system 110z through the network 180b. After that, the images and audio are transmitted to the image computing server 200. Although the cameras 112a to 112z are separated from the camera adapters 120a to 120z in the present exemplary embodiment, the cameras 112a to 112z and the camera adapters 120a to 120z may be integrated in the same cases. In this case, the microphones 111a to 111z may be incorporated in the integrated camera 112 or externally connected to the camera 112.

Next, the configuration and operation of the image computing server 200 will be described. The image computing server 200 according to the present exemplary embodiment performs processing on data acquired from the sensor system 110z. The image computing server 200 includes the front-end server 230, a database 250 (hereinafter referred to also as a DB), a back-end server 270, and a time server 290. The image computing server 200 generates a virtual viewpoint image using three-dimensional model information as a processing result of image processing of the camera adapters 120a to 120z.

The time server 290 has a function of delivering a time and a synchronization signal and delivers a time and a synchronization signal to the sensor systems 110a to 110z through the switching hub 180. The camera adapters 120a to 120z which have received the time and the synchronization signal perform generator locking (Genlock) on the cameras 112a to 112z based on the time and the synchronization signal so as to perform image frame synchronization. Specifically, the time server 290 synchronizes imaging timings of the plurality of cameras 112. With this configuration, the image processing system 100 can generate a virtual viewpoint image based on a plurality of captured images captured at the same timing. Consequently, degradation in the quality of the virtual viewpoint image caused by a difference among the imaging timings can be suppressed. Although the time server 290 manages the time synchronization of the plurality of cameras 112 in the present exemplary embodiment, the present disclosure is not limited to this and the individual cameras 112 or the individual camera adapters 120 may perform processing for the time synchronization.

The front-end server 230 reconstructs segmented transmission packets using images and audio obtained from the sensor system 110z and converts a data format. After that, the front-end server 230 writes the images and audio into the database 250 in accordance with identifiers of the cameras, data types, and frame numbers.

Next, the back-end server 270 accepts designation of a viewpoint from the virtual camera operation UI 330, reads the corresponding image and audio data from the database 250 based on the accepted viewpoint, and generates a virtual viewpoint image by performing rendering processing.

The configuration of the image computing server 200 is not limited to this configuration. For example, at least two of the front-end server 230, the database 250, and the back-end server 270 may be integrated with each other. At least one of the front-end server 230, the database 250, and the back-end server 270 may be provided in plural in the image computing server 200. A device other than the devices described above may be included in an arbitrary position of the image computing server 200. Moreover, the end-user terminal 190 or the virtual camera operation UI 330 may have at least some of the functions of the image computing server 200.

An image which has been subjected to rendering processing is transmitted from the back-end server 270 to the end-user terminal 190 so that the user who operates the end-user terminal 190 can view the image and listen to the audio corresponding to the designated viewpoint. Specifically, the back-end server 270 generates a virtual viewpoint content based on captured images (multiple viewpoint images) captured by the plurality of cameras 112 and viewpoint information. More specifically, the back-end server 270 generates a virtual viewpoint content based on, for example, image data on a predetermined area extracted by the plurality of camera adapters 120 from the images captured by the plurality of cameras 112 and a viewpoint designated by a user operation. The back-end server 270 supplies the generated virtual viewpoint content to the end-user terminal 190. The extraction of the predetermined area by the camera adapter 120 will be described in detail blow.

The virtual viewpoint content in the present exemplary embodiment is a content that is obtained as an image when an image of a subject is captured from a virtual viewpoint and includes a virtual viewpoint image. In other words, the virtual viewpoint image is an image representing a view from a designated viewpoint. A virtual viewpoint may be designated by the user or may be automatically designated based on a result of an image analysis or the like. Specifically, examples of the virtual viewpoint image include an arbitrary viewpoint image (a free viewpoint image) corresponding to a viewpoint arbitrarily designated by the user. Examples of the virtual viewpoint image also include an image corresponding to a viewpoint designated by the user from among a plurality of candidates and an image corresponding to a viewpoint automatically designated by a device. Although a case where the virtual viewpoint content includes audio data is mainly described as an example in the present exemplary embodiment, the audio data may not be included in the virtual viewpoint content.

The back-end server 270 may perform encoding on the virtual viewpoint image in accordance with a standard technique as typified by H.264 or HEVC before transmitting the virtual viewpoint image to the end-user terminal 190 using an MPEG-DASH protocol. The virtual viewpoint image may be transmitted to the end-user terminal 190 without compression. In particular, the former method of performing encoding is employed assuming that a smartphone or a tablet is used as the end-user terminal 190, while the latter method is employed assuming that a display capable of displaying a non-compressed image is used. Specifically, the back-end server 270 can change an image format depending on the type of the end-user terminal 190. The image transmission protocol is not limited to MPEG-DASH, and HTTP Live Streaming (HLS) or other transmission methods may also be used.

In this manner, the image processing system 100 has three functional domains, i.e., a video collection domain, a data storage domain, and a video generation domain. The video collection domain includes the sensor systems 110a to 110z. The data storage domain includes the database 250, the front-end server 230, and the back-end server 270. The video generation domain includes the virtual camera operation UI 330 and the end-user terminal 190. The configuration of the image processing system 100 is not limited to this. For example, the virtual camera operation UI 330 may directly obtain images from the sensor systems 110a to 110z. However, in the present exemplary embodiment, a method for arranging the data storage function in an intermediate portion is employed instead of the method for directly obtaining images from the sensor systems 110a to 110z. More specifically, the front-end server 230 converts image data and audio data generated by the sensor systems 110a to 110z and meta-information of the data into a common schema and a common data type of the database 250. With this configuration, even when the type of the cameras 112 of the sensor systems 110a to 110z is changed to another type, a difference in the change can be absorbed by the front-end server 230 and registered in the database 250. Accordingly, the possibility that the virtual camera operation UI 330 may not appropriately operate when the type of the cameras 112 is changed to another type can be reduced.

The virtual camera operation UI 330 does not directly access the database 250 but accesses the database 250 through the back-end server 270. The back-end server 270 performs common processing associated with image generation processing, and the virtual camera operation UI 330 processes a difference portion of an application associated with an operation UI. Accordingly, in the development of the virtual camera operation UI 330, development of a UI operation device and development for functional requirements of an UI for operating a virtual viewpoint image to be generated can be focused on. The back-end server 270 can add or delete common processing associated with image generation processing in response to a request from the virtual camera operation UI 330. In this way, a request from the virtual camera operation UI 330 can be flexibly dealt with.

As described above, in the image processing system 100, the back-end server 270 generates a virtual viewpoint image based on image data obtained by image capturing performed by the plurality of cameras 112 for capturing images of a subject from a plurality of directions. The configuration of the image processing system 100 according to the present exemplary embodiment is not limited to the physical configuration described above, and the image processing system 100 may be logically configured. Further, the connection among the sensor systems 110a to 110z is not limited to the physical cascade connection by a daisy chain, but instead a connection in which a path is logically determined may be used.

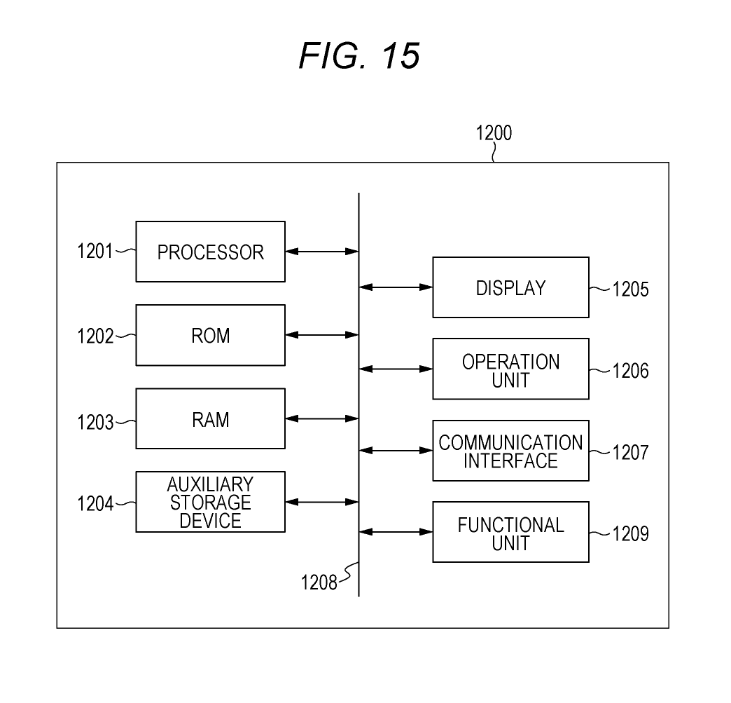

Next, the hardware configuration of each device in the image processing system 100 according to the present exemplary embodiment will be described with reference to FIG. 15. Referring to FIG. 15, a device 1200 corresponds to each of the devices (the camera 112, the camera adapter 120, the front-end server 230, the database 250, and the back-end server 270) of the image processing system 100. The device 1200 also corresponds to each of the control station 310, the virtual camera operation UI 330, and the end-user terminal 190. The device 1200 includes a processor 1201, a read only memory (ROM) 1202, a random access memory (RAM) 1203, an auxiliary storage device 1204, a display 1205, an operation unit 1206, a communication interface 1207, a bus 1208, and a functional unit 1209.

The processor 1201 controls the entire device 1200. An example of the processor 1201 may be a central processing unit (CPU). The processor 1201 controls the entire device 1200 by using a computer program or data stored in the ROM 1202 or RAM 1203. The processor 1201 may be an application-specific integrated circuit (ASIC) or a field-programmable gate array (FPGA).

The ROM 1202 stores programs and parameters which are not required to be changed. The RAM 1203 temporarily stores programs and data supplied from the auxiliary storage device 1204 and data externally supplied through the communication interface 1207. The auxiliary storage device 1204 is composed of a hard disk drive or the like, and stores content data, such as still images and moving images.

The display 1205 is composed of, for example, a liquid crystal display, and displays a graphical user interface (GUI) and various pieces of information. The operation unit 1206 is composed of, for example, a keyboard or a mouse, and inputs various instructions to the processor 1201 according to a user operation. The communication interface 1207 communicates with an external device. For example, the communication interface 1207 may perform either a wired communication or a wireless communication. In the case of performing a wired communication, the communication interface 1207 is a piece of hardware for performing Ethernet. In the case of performing a wired communication, the communication interface 1207 is, for example, a circuit, a chip, and an antenna for performing a communication based on the IEEE 802.11 standard. The bus 1208 connects the units to each other to transmit information. The functional unit 1209 is a piece of hardware for implementing a predetermined function. When the functional unit 1209 is used as the camera 112, the functional unit 1209 can serve as an image capturing unit for capturing images. The image capturing unit includes a lens, an image sensor, and an image processing processor.

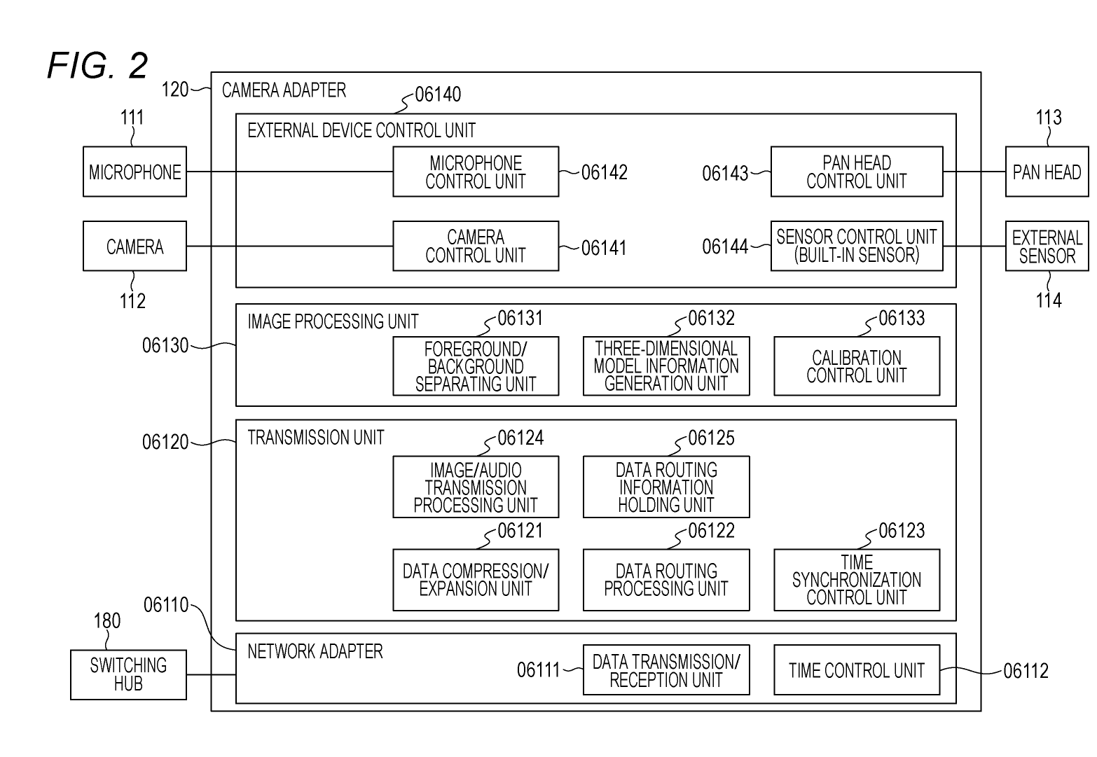

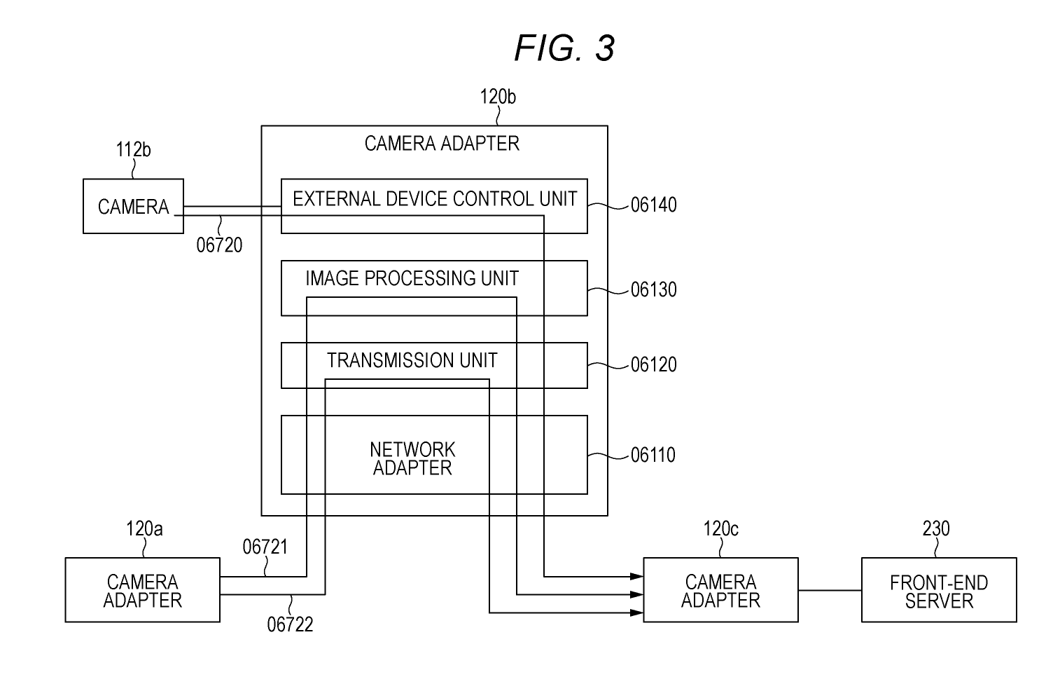

Next, the functional configuration of the camera adapter 120 will be described with reference to FIG. 2. A flow of data among functional blocks of the camera adapters 120 will be described in detail below with reference to FIG. 3. Each functional configuration of the camera adapter 120 is implemented in such a manner that the processor 1201 of the camera adapter 120 controls each piece of hardware and performs operation and processing on information. The camera adapter 120 includes a network adapter 06110, a transmission unit 06120, an image processing unit 06130, and an external device control unit 06140.

The network adapter 06110 includes a data transmission/reception unit 06111 and a time control unit 06112. The data transmission/reception unit 06111 performs data communication with other camera adapters 120, the front-end server 230, the time server 290, and the control station 310 via the daisy chain 170, a network 291, and the network 310a. For example, the data transmission/reception unit 06111 outputs a foreground image and a background image, which are separated by a foreground/background separation unit 06131 from the image captured by the camera 112, to another camera adapter 120. The output destination camera adapter 120 is the next camera adapter 120 in the order of the camera adapters 120 in the image processing system 100 that is preliminarily determined depending on the processing of a data routing processing unit 06122. Each camera adapter 120 outputs foreground images and background images, and a virtual viewpoint image is generated based on the foreground images and background images captured from a plurality of viewpoints. The camera adapters 120 may not output background images but output foreground images separated from captured images.

The time control unit 06112 conforms with Ordinary Clock based on the IEEE 1588 standard, for example, has a function of storing a time stamp of data which is transmitted to and received from the time server 290, and performs time synchronization with the time server 290. The time control unit 06112 may realize the time synchronization with the time server 290 in accordance with other standards, such as the EtherAVB standard, NTP, or a unique protocol, instead of the IEEE 1588 standard. Time information may be acquired from a global positioning system (GPS) or the like. Although a network interface card (NIC) is used as the network adapter 06110 in the present exemplary embodiment, other similar interfaces may be used instead of the NIC. Furthermore, the IEEE 1588 is updated as standards, such as the IEEE 1588-2002 or the IEEE 1588-2008, and the IEEE 1588-2008 is also referred to as “precision time protocol version 2 (PTPv2)”.

The transmission unit 06120 has a function of controlling transmission of data to the switching hub 180 and the adjacent camera adapter 120 through the network adapter 06110 and includes the following functional units.

A data compression/expansion unit 06121 has a function of performing compression on data transmitted and received through the data transmission/reception unit 06111 using a predetermined compression method, a predetermined compression rate, and a predetermined frame rate and a function of expanding compressed data.

The data routing processing unit 06122 determines an output destination of data received by the data transmission/reception unit 06111 and data processed by the image processing unit 06130 by using routing information stored in a data routing information holding unit 06125 to be described below. The data routing processing unit 06122 also has a function of creating additional information about a message for transmitting data to the determined output destination. The output destination preferably corresponds to one of the camera adapters 120 which corresponds to one of the cameras 112 which focuses on the same gazing point in terms of image processing because the image frame correlation among the cameras 112 is high. The order of the camera adapters 120 which output the foreground images and the background images in a relay format in the image processing system 100 is determined in accordance with determinations performed by the data routing processing unit 06122 of each of the plurality of camera adapters 120.

A time synchronization control unit 06123 conforms to a precision time protocol (PTP) of the IEEE 1588 standard and has a function of performing processing associated with the time synchronization with the time server 290. The time synchronization control unit 06123 may perform the time synchronization using other similar protocols instead of the PTP.

An image/audio transmission processing unit 06124 has a function of creating a message for transferring image data or audio data to one of the other camera adapters 120 or the front-end server 230 through the data transmission/reception unit 06111. The message includes the image data or audio data and meta-information of the image data or audio data. The meta-information of the present exemplary embodiment includes a time code obtained when an image is captured or audio is sampled or a sequence number, a data type, and an identifier indicating the camera 112 or the microphone 111. The image data or audio data to be transmitted may be compressed by the data compression/expansion unit 06121. Further, the image/audio transmission processing unit 06124 receives a message through the data transmission/reception unit 06111 from one of the other camera adapters 120. Then, the image/audio transmission processing unit 06124 restores data information which is fragmented in a packet size prescribed by a transmission protocol so as to obtain image data or audio data in accordance with a data type included in the message. In a case where data is compressed after the data is restored, the data compression/expansion unit 06121 performs expansion processing.

The data routing information holding unit 06125 has a function of storing routing information for determining a transmission destination of data transmitted or received by the data transmission/reception unit 06111. A routing method will be described below.

The image processing unit 06130 has a function of performing processing on image data that is captured by the camera 112 and received from one of the other camera adapters 120 under control of a camera control unit 06141, and includes the following functional units.

The foreground/background separation unit 06131 has a function of separating a foreground image and a background image from each other in image data obtained by the camera 112. Specifically, the foreground/background separation unit 06131 of each of the plurality of camera adapters 120 extracts a predetermined area from an image captured by a corresponding one of the plurality of cameras 112. The predetermined area is, for example, a foreground image obtained as a result of object detection performed on a captured image. The foreground/background separation unit 06131 separates a foreground image and a background image from each other in a captured image by the extraction. As the predetermined area, a foreground image may be extracted from a plurality of pieces of image data received from a plurality of other camera adapters 120 and image data obtained by the camera 112. The object corresponds to, for example, a human figure. However, the object may be a specific person (a player, a coach, and/or a referee) or may be an object, such as a ball or a goal, which has a predetermined image pattern. Alternatively, a moving body may be detected as the object. When a foreground image including an important object, such as a human figure, and a background area which does not include such an important object are processed after being separated from each other, the quality of an image of a portion corresponding to the object in a virtual viewpoint image generated in the image processing system 100 can be improved. Further, the separation between a foreground image and a background image is performed by each of the camera adapters 120 so that a load in the image processing system 100 including the plurality of cameras 112 can be dispersed. The predetermined area is not limited to a foreground image, but instead may be, for example, a background image.

A three-dimensional model information generation unit 06132 has a function of generating image information associated with a three-dimensional model in accordance with a stereo camera principle, for example, using a foreground image separated by the foreground/background separation unit 06131 and a foreground image supplied from one of the other camera adapters 120.

A calibration control unit 06133 has a function of obtaining image data required for calibration from the camera 112 through the camera control unit 06141 and transmitting the image data to the front-end server 230 which performs calculation processing associated with the calibration. The calculation processing associated with the calibration of the present exemplary embodiment is carried out by the front-end server 230, but a node for performing the calculation processing is not limited to the front-end server 230. The calculation processing may be carried out by another node, such as the control station 310 and the camera adapter 120 (including other camera adapters 120). The calibration control unit 06133 also has a function of performing calibration (dynamic calibration) on image data supplied from the camera 112 through the camera control unit 06141 during image capturing in accordance with a preset parameter. The calibration control unit 06133 also has a function of performing image correction, such as correction of a color, brightness, or the like, on the image captured from the camera 112 using the image data received from one of the other camera adapters 120.

The external device control unit 06140 has a function of controlling the devices connected to the camera adapter 120 and includes the following functional blocks.

The camera control unit 06141 is connected to the camera 112 and has a function of performing control of the camera 112, acquisition of a captured image, provision of a synchronization signal, and setting of a time. Examples of the control of the camera 112 include setting and reference of shooting parameters (settings of the number of pixels, a color depth, a frame rate, white balance, and the like), acquisition of a state of the camera 112 (states of image capturing, stopping, synchronization, an error, and the like), start and stop of image capturing, and focus adjustment. Although the focus adjustment is performed through the camera 112 in the present exemplary embodiment, when a detachable lens is attached to the camera 112, the camera adapter 120 may be connected to the lens so as to directly adjust the lens. Further, the camera adapter 120 may perform the lens adjustment, such as zoom, through the camera 112. The provision of a synchronization signal is performed when an imaging timing (a control clock) is provided to the camera 112 using a time when the time synchronization control unit 06123 is synchronized with the time server 290. The time setting is performed by providing the time when the time synchronization control unit 06123 is synchronized with the time server 290 as a time code which conforms with a format of, for example, SMPTE12M. Thus, a time code assigned to image data received from the camera 112 is appended. The format of the time code is not limited to SMPTE12M, and other formats may be employed. Further, the camera control unit 06141 may not append the time code to the camera 112 but may append the time code to the image data received from the camera 112.

A microphone control unit 06142 is connected to the microphone 111 and has a function of performing control of the microphone 111, start and stop of sound collection, acquisition of collected audio data, and the like. Examples of the control of the microphone 111 include gain adjustment and acquisition of a state. As with the camera control unit 06141, the microphone control unit 06142 provides the microphone 111 with a timing of audio sampling and a time code. As clock information indicating the timing of audio sampling, time information supplied from the time server 290 is converted into a word clock of, for example, 48 KHz, and supplied to the microphone 111.

A pan head control unit 06143 is connected to the pan head 113 and has a function of controlling the pan head 113. Examples of the control of the pan head 113 include pan/tilt control and acquisition of a state.

A sensor control unit 06144 is connected to the external sensor 114 and has a function of acquiring sensor information sensed by the external sensor 114. For example, if a gyroscope sensor is used as the external sensor 114, information indicating vibration may be acquired. By using the vibration information acquired by the sensor control unit 06144, the image processing unit 06130 can generate an image which is less affected by the vibration of the camera 112 before the processing performed by the foreground/background separation unit 06131. The vibration information is used, for example, when image data obtained by an 8K camera is extracted in a size smaller than an original 8K size by taking the vibration information into consideration and positioning is performed with an image captured by the camera 112 installed adjacent to the target camera 112. Accordingly, even if structure vibration of a building is transmitted to the cameras 112 in different frequencies, positioning is performed by this function of the camera adapter 120. As a result, image data which is processed electronically vibration-proof can be generated, and an effect of reducing a processing load of positioning performed for a number of cameras 112 in the image computing server 200 can be obtained. The sensor of the sensor system 110 is not limited to the external sensor 114, and the same effect can be obtained even if the sensor is incorporated in the camera adapter 120.

FIG. 3 illustrates the flow of data among the camera adapters 120a, 120b, and 120c. The camera adapter 120a is connected to the camera adapter 120b, and the camera adapter 120b is connected to the camera adapter 120c. The camera adapter 120c is connected to the front-end server 230.

The external device control unit 06140 of the camera adapter 120b acquires captured image data 06720 from the camera 112b, and outputs the acquired image data to the image processing unit 06130. The image processing unit 06130 of the camera adapter 120b receives input data of the captured image data 06720 from the camera 112b and input data 06721 on which image processing is performed from the camera adapter 120a. The input data is used to, for example, extract foreground data included in the captured image data, generate background data, and generate a three-dimensional model. The extracted and generated data is output to the transmission unit 06120.

The transmission unit 06120 of the camera adapter 120b analyzes data received from the camera adapter 120a, and outputs data required for image processing in the image processing unit 06130 to the image processing unit 06130. If there is no need for the image processing unit 06130 to perform image processing on the image received from the camera adapter 120a, the transmission unit 06120 outputs the received data to the camera adapter 120c through the network adapter 06110 without outputting the received data to the image processing unit 06130. Further, the network adapter 06110 outputs the data received from the image processing unit 06130 to the camera adapter 120c or 120a depending on the type of the data. The network adapter 06110 performs processing, such as compression, setting of a frame rate, and packetization, on the data and then outputs the data.

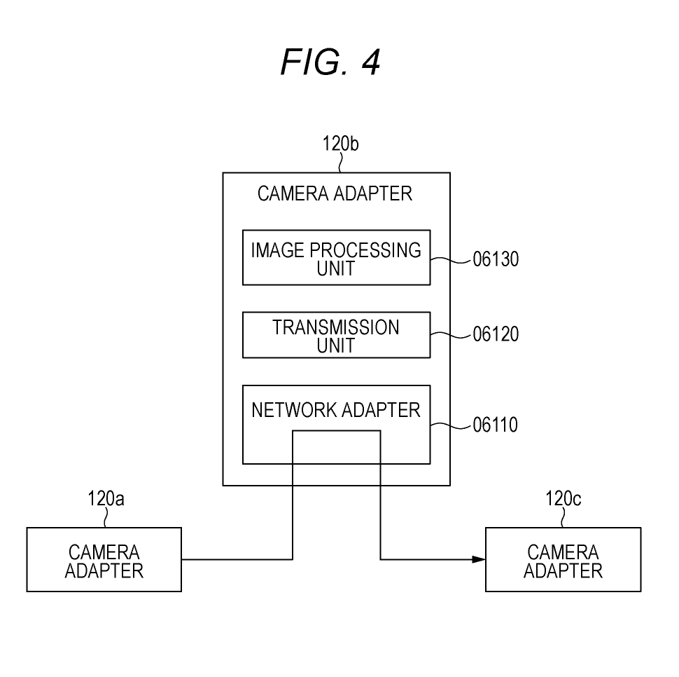

Bypass transmission in a bypass control mode of the camera adapter 120 will be described with reference to FIG. 4. The bypass transmission in the bypass control mode is a function for, for example, the camera adapter 120b transfers the data received from the camera adapter 120a to the next camera adapter 120c without performing the routing control by the data routing processing unit 06122.

The camera adapter 120 controls the network adapter 06110 to perform bypass transmission when the camera 112 is in an imaging stop state, a calibration state, an error processing state, or a power OFF state.

For example, assume a case where image capturing cannot be performed by the camera 112b due to a failure in the camera 112b or power-off of the camera 112b. If the camera adapter 120b cannot acquire a captured image from the camera 112b, the operation mode transits to the bypass control mode. In such a state, when the camera adapter 120b receives a foreground image from the camera 112a, there is no captured image obtained from the camera 112b and thus three-dimensional model information cannot be generated using the foreground image received from the camera adapter 120a. Accordingly, the camera adapter 120b performs bypass transmission control without performing image processing for generating three-dimensional model information, thereby transmitting the foreground image generated by the camera adapter 120a to the next camera adapter 120c. However, in this case, image processing based on the foreground image generated by the camera adapter 120a is not executed and three-dimensional model information based on the foreground image generated by the camera adapter 120a is not generated. The generation of a virtual viewpoint image in a state where three-dimensional model information based on some of the foreground images may cause degradation of the image quality and an increase in time required for processing in a subsequent stage. The camera adapter 120 of the present exemplary embodiment adds information for causing the camera adapter 120 at the subsequent stage to execute image processing on the generated foreground image so as to prevent degradation of the image quality of the virtual viewpoint image and an increase in processing time which may be caused due to the bypass transmission. When information for performing image processing is added to a foreground image generated by the camera adapter 120 other than the adjacent camera adapter 120, the camera adapter 120 executes image processing on the foreground image to generate three-dimensional model information. With this configuration, even when the adjacent camera adapter 120 is in the bypass control mode, any one of the camera adapters 120 at the subsequent stage executed image processing on the foreground image to be transmitted and generates three-dimensional model information. Accordingly, it is possible to prevent degradation of the image quality of the virtual viewpoint image and an increase in processing time which may be caused due to the bypass transmission.

Further, the camera adapter 120 may control the network adapter 06110 to perform the bypass transmission even when a malfunction or the like has occurred in the transmission unit 06120, the image processing unit 06130, or the like. Further, the network adapter 06110 may detect the state of the transmission unit 06120 and actively transit to the bypass control mode. A sub-CPU for detecting an error state or a stop state of the transmission unit 06120 or the image processing unit 06130 may be disposed in the camera adapter 120b. When the sub-CPU detects the error state, the network adapter 06110 may be shifted to the bypass control mode.

Further, the camera adapter 120 may transit from the bypass control mode to a normal communication mode when the state of the camera 112 transits from the calibration state to the imaging state, or when the transmission unit 06120 or the like is restored from the malfunction.

The bypass control mode enables the camera adapter 120b to rapidly transfer data and transfer data to the next camera adapter 120c even when it is difficult to make a determination as to data routing due to an unintended failure or the like.

When the camera adapter 120b transits to the bypass control mode, the foreground/background separation unit 06131 of the camera adapter 120c extracts a foreground image by using output data from the camera adapter 120a instead of output data from the camera adapter 120b. The three-dimensional model information generation unit 06132 of the camera adapter 120c also generates image information related to the three-dimensional model by using the foreground image supplied from the camera adapter 120a. The calibration control unit 06133 of the camera adapter 120c also performs image correction based on the output data from the camera adapter 120a.

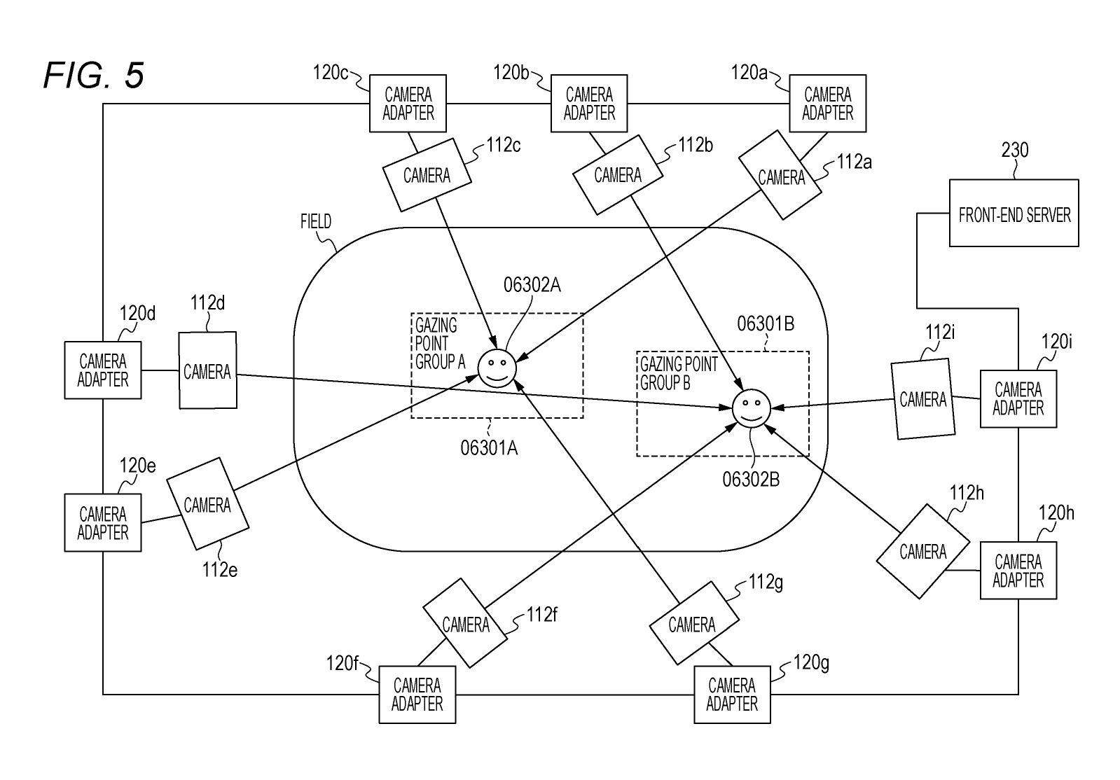

Next, a gazing point group will be described with reference to FIG. 5. The term “gazing point group” used herein refers to a camera group including one or more camera 112 installed in such a manner that the optical axis faces the same gazing point. In other words, the gazing point group is a camera group composed of cameras having the same gazing point among a plurality of cameras. The gazing point group may be a camera group composed of one or more cameras 112 installed in such a manner that the optical axis faces the same area. Alternatively, the gazing point group may be a camera group composed of one or more cameras 112 in which an imaging range within which images of the same area can be captured is set. Referring to FIG. 5, each camera 112 in the gazing point group is installed in such a manner that the optical axis faces a specific gazing point 06302. The cameras 112 which are classified in the same gazing point group 06301 are installed in such a manner that the cameras 112 face the same gazing point 06302.

FIG. 5 illustrates an example in which two gazing points 06302, i.e., a gazing point A (06302A) and a gazing point B (06302B), are set, nine cameras (112a to 112i) are installed, and four cameras (112a, 112c, 112e, and 112g) face the same gazing point A (06302A) and belong to a gazing point group A (06301A). The other five cameras (112b, 112d, 112f, 112h, and 112i) face the same gazing point B (06302B) and belong to a gazing point group B (06301B).

In this case, a pair of cameras 112 which belong to the same gazing point group 06301 and which have a small number of connection hops is represented as the cameras 112 which are logically adjacent to each other. For example, the camera 112a and the camera 112b are physically adjacent to each other but belong to different gazing point groups 06301, and therefore, the camera 112a and the camera 112b are not logically adjacent to each other. The camera 112c is logically adjacent to the camera 112a. On the other hand, the camera 112h and the camera 112i are not only physically adjacent to each other but also logically adjacent to each other. The camera adapters 120 perform different processing depending on a result of a determination as to whether a physically-adjacent camera 112 is also a logically-adjacent camera 112. In the present exemplary embodiment, unless otherwise stated, a physically-adjacent camera adapter 120 and a logically-adjacent camera adapter 120 are distinguished from each other and but both are referred to as an adjacent camera adapter 120.

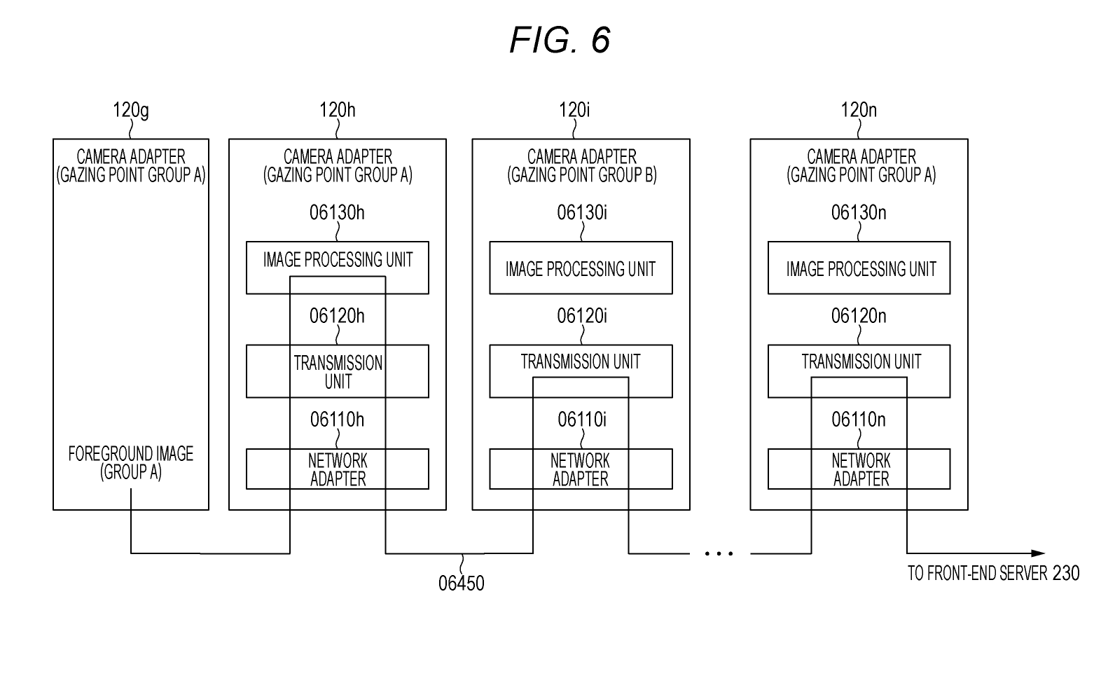

The bypass transmission according to the gazing point group will be described with reference to FIG. 6. The image processing system 100 performs a setting of the number of camera adapters 120 belonging to each gazing point group, and a setting of which camera adapter 120 belongs which gazing point group. It is assumed that, in FIG. 6, the camera adapter 120g, camera adapter 120h, and the camera adapter 120n belong to the gazing point group A and the camera adapter 120i belongs to the gazing point group B.

FIG. 6 illustrates a route 06450 of a foreground image created by the camera adapter 120g. The foreground image created by the camera adapter 120g is finally transmitted to the front-end server 230. In FIG. 6, descriptions of the background image, the three-dimensional model information, the control message, and the foreground images generated by the camera adapters 120h, 120i, and 120n are omitted.

When the camera adapter 120h receives the foreground image created by the camera adapter 120g through a network adapter 06110h, the camera adapter 120h determines an image processing method. A transmission unit 06120h of the camera adapter 120h determines a routing destination of the foreground image created by the camera adapter 120g. The transmission unit 06120h determines whether the camera adapter 120g which has created the received foreground image belongs the same gazing point group (group A in this case). When determining that the camera adapter 120g which has created the received foreground image belongs to the same gazing point group, the transmission unit 06120h determines whether the received foreground image is a foreground image required for generating the three-dimensional model information. The determination as to whether the received foreground image is a foreground image required for generating the three-dimensional model information may be made based on the image-capturing area of the corresponding camera 112. For example, when the correlation between the received foreground image and the foreground image captured by the camera 112 to be connected, the camera adapter 120h determines that the received foreground image is a foreground image required for generating the three-dimensional model information. When it is determined that the received foreground image is a foreground image required for generating the three-dimensional model information, the transmission unit 06120h outputs the received foreground image to an image processing unit 06130h. The image processing unit 06130h executes image processing such as creation of three-dimensional model information based on the foreground image created by the camera adapter 120g. The camera adapter 120h transfers the foreground image supplied from the camera adapter 120g to the next camera adapter 120i.

The camera adapter 120i receives the foreground image created by the camera adapter 120g from the camera adapter 120h. A transmission unit 06120i of the camera adapter 120i determines that the gazing point group to which the camera adapter 120g belongs is different from the gazing point group to which the camera adapter 120i belongs, and thus determines to transfer the foreground image created by the camera adapter 120g to the next camera adapter 120 without processing the received image in an image processing unit 06130i.

When the camera adapter 120n receives the foreground image created by the camera adapter 120g through a network adapter 06110n, a transmission unit 06120n determines the routing destination. The transmission unit 06120n determines whether the camera adapter 120n belongs to the gazing point group to which the camera adapter 120g also belongs. The camera adapter 120n determines whether the foreground image supplied from the camera adapter 120g is a foreground image necessary for an image processing unit 06130n to generate the three-dimensional model information. When determining that the foreground image supplied from the camera adapter 120g is not required for generating the three-dimensional model information, the camera adapter 120n determines to transfer the received foreground image to the next camera adapter 120 without processing the received foreground image in the image processing unit 06130n.

Thus, the transmission unit 06120 of each camera adapter 120 determines whether the received data is data used for image processing such as creation of three-dimensional model information in the image processing unit 06130. When determining that the received data is not data used for image processing, the camera adapter 120 transfers the data to the next camera adapter 120 without transferring the data to the image processing unit 06130. When determining that the data has low correlation with the foreground image captured by the camera 112 to be connected, the camera adapter 120 transfers the data to the next camera adapter 120 without transferring the data to the image processing unit 06130. Specifically, in the transmission of data through the daisy chain 170, processing for selecting data required for each camera adapter 120 and sequentially generating three-dimensional model information is carried out. This leads to a reduction in processing load and processing time associated with a data transfer from the reception of data in the camera adapter 120 to the transfer of the data. Further, the camera adapter 120 performs image processing, such as generation of three-dimensional model information, using the image data from other camera adapters 120 belonging to the same gazing point group, thereby enabling generation of three-dimensional model information with high accuracy. Even in a case where the image data is supplied from other camera adapters 120 belonging to the same gazing point group, if the image data has low correlation with the camera adapter 120 itself, the camera adapter 120 does not generate three-dimensional model information, and if the image data has high correlation with the camera adapter 120 itself, the camera adapter 120 generates three-dimensional model information. Accordingly, three-dimensional model information can be generated with higher accuracy than when the bypass transmission control is carried out, which leads to a reduction in degradation of the image quality of the virtual viewpoint image due to the bypass transmission control.

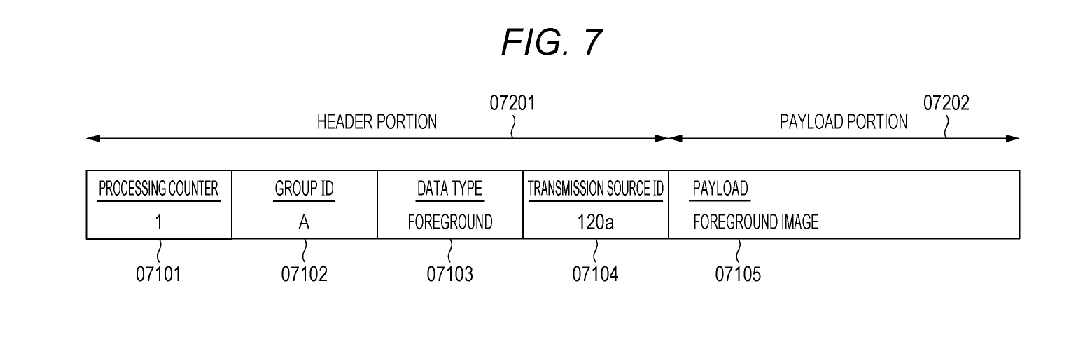

Next, additional information included in transmission data, such as a foreground image, which is transferred among the camera adapters 120 will be described with reference to FIG. 7. The format of transmission data is not limited to one illustrated in the figure, but instead may include other information that is not illustrated in the present exemplary embodiment. The order of data to be arranged is not limited to that described in the present exemplary embodiment. Descriptions of an IP header and the like are herein omitted. Additional information about transmission data will be described by illustrating an example in which a foreground image as illustrated in FIG. 7 is transmitted.

The transmission data includes additional information indicated by a header portion 07201 and payload data indicated by a payload portion 07202. The header portion 07201 includes a processing counter 07101, a group ID 07102, a data type 07103, and header information of a transmission source ID 07104. The header information is not limited to that illustrated in FIG. 7, but instead may include other information. The header portion 07201 and the foreground image compressed by the data compression/expansion unit 06121 are combined by the data routing processing unit 06122, and the header portion 07201 combined with the foreground image are transferred to the adjacent camera adapter 120 by the network adapter 06110. Further, the data routing processing unit 06122 analyzes the header portion 07201 included in the data received from the adjacent camera adapter 120. Depending on the result of analysis of the header portion 07201, it is determined whether to transmit the foreground image to the image processing unit 06130, or to transmit the foreground image to the adjacent camera adapter 120 without passing through the image processing unit 06130. The camera adapter 120 determines whether to execute image processing on the received data.

The processing counter 07101 represents information used for determining whether to transmit the foreground image received from the adjacent camera adapter 120 to the image processing unit 06130. When the value of the processing counter 07101 in the header portion of the received foreground image is “1”, the camera adapter 120 determines that image processing is executed on the received foreground image. When the value of the processing counter 07101 is “1”, the camera adapter 120 outputs the received foreground image to the three-dimensional model information generation unit 06132, and the three-dimensional model information generation unit 06132 generates three-dimensional model information. When the received foreground image is processed in the image processing unit 06130, the camera adapter 120 adds, to the foreground image, the header portion 07201 in which a value obtained by decrementing the processing counter 07101 is newly set. Further, the camera adapter 120 transfers the foreground image to the adjacent camera adapter 120 through the network adapter 06110.

When the value of the processing counter 07101 in the header portion of the received foreground image is less than “1”, the camera adapter 120 determines that image processing is not executed on the received foreground image. When the received foreground image is not processed in the image processing unit 06130, the camera adapter 120 transfers the foreground image to the adjacent camera adapter 120 through the network adapter 06110 without changing the value of the processing counter 07101.

The group ID 07102 is an identifier for identifying the gazing point group illustrated in FIG. 5. In the present exemplary embodiment, an identifier is used as information for identifying the gazing point group, but the disclosure is not limited to an identifier. The information may include metadata about the gazing point group. The camera adapter 120 determines whether the received foreground image belongs the same gazing point group by referring to the group ID 07102.

The data type 07103 includes information for identifying the type of data stored in the payload portion 07202. The data type 07103 indicates, for example, whether data stored in the payload portion 07202 is a foreground image. Further, the data type 07103 indicates, for example, whether data stored in the payload portion 07202 is a foreground image, a background image, or three-dimensional data information. The camera adapter 120 selects a content of image processing by referring to the data type 07103. For example, if the received data is a foreground image, the three-dimensional model information generation unit 06132 of the camera adapter 120 generates three-dimensional model information, and if the received data is not a foreground image, the received data is transferred to the next camera adapter 120 without performing processing in the three-dimensional model information generation unit 06132.

The transmission source ID 07104 is transmission source information including an identifier for identifying the camera adapter 120 which has created data. The transmission source ID 07104 is not limited to an identifier, but instead may include metadata about the transmission source camera adapter 120.

In the payload portion 07202, the foreground image compressed by the data compression/expansion unit 06121 is stored in a payload 07105. The payload portion 07202 may include not only a foreground image, but also metadata of the foreground image and parameters for compression used during expansion of data.

The transmission data may include, instead of the processing counter 07101, information indicating that the camera adapter 120 of the transmission source is in the bypass control mode. Further, the transmission data may include information indicating whether there is a need to perform image processing on the data included in the payload portion 07202.

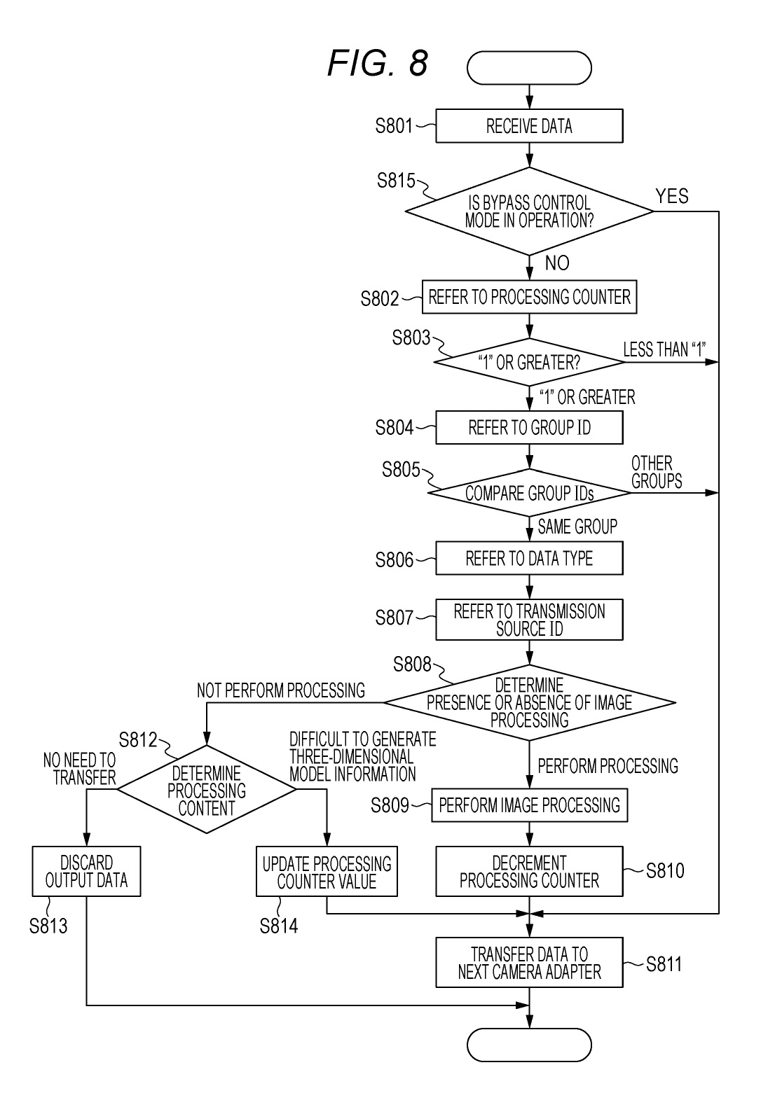

Next, an operation to be performed when the camera adapter 120 receives data will be described with reference to a flowchart of FIG. 8. The flowchart illustrated in FIG. 2 is implemented in such a manner that the processor 1201 of the camera adapter 120 executes operation and processing of information and control of each piece of hardware. Some or all of the steps of the flowchart illustrated in FIG. 8 may be implemented by hardware such as a field programmable gate array (FPGA) or an application specific integrated circuit (ASIC). The flowchart illustrated in FIG. 8 is started when the camera adapter 120 receives data.

When the camera adapter 120 receives data from the adjacent camera adapter 120 (S801), it is determined whether the camera adapter 120 is operating in the bypass control mode. When the camera adapter 120 is operating in the bypass control mode, the processing proceeds to step S811 to be described below. On the other hand, when the camera adapter 120 is not operating in the bypass control mode, the processing proceeds to step S802.

When the camera adapter 120 is not operating in the bypass control mode, the camera adapter 120 determines whether to execute image processing on the data stored in the payload portion by referring to the additional information included in the header portion of the received data. First, the camera adapter 120 refers to the processing counter included in the header portion of the received data (S802). If the processing counter is not included in the received data, the camera adapter 120 may transmit the received data to the next camera adapter 120 without performing the subsequent processing (S811). When the value of the processing counter is less than “1”, the camera adapter 120 transmits the data to the next camera adapter 120 through the network adapter 06110 (S811).

When the referenced value of the processing counter is equal to or greater than “1”, the camera adapter 120 refers to the group ID included in the received data (S804). The camera adapter 120 determines whether the camera adapter which has generated the received data belongs to the gazing point group to which the camera adapter 120 itself belongs based on the group ID included in the received data (S805). When the group ID is not included in the received data, the camera adapter 120 may transmit the received data to the next camera adapter 120 without performing the subsequent processing. When the group ID is not included in the received data, the camera adapter 120 may proceed processing to step S806 to be described below.

In step S805, if it is determined that the camera adapter which has generated the received data belongs to the gazing point group which is different from the gazing point group to which the camera adapter 120 itself belongs, the camera adapter 120 transmits the received data to the next camera adapter 120 through the network adapter 06110 (S811). In step S805, if it is determined that the camera adapter which has generated the received data belongs to the gazing point group to which the camera adapter 120 itself belongs, the camera adapter 120 checks the data type of the received data by referring to the data type included in the received data (S806). When the data type is not included in the received data, the camera adapter 120 may transmit the received data to the next camera adapter 120 without performing the subsequent processing.

The camera adapter 120 refers to the transmission source ID of the received data (S807). The camera adapter 120 determines whether there is a need to perform image processing on the received data based on the additional information (S808). Specifically, the camera adapter 120 determines whether to perform image processing on the received data based on the processing counter, group ID, transmission source ID, and data type of the received data. Further, the camera adapter 120 determines a method for processing the received data and a content of processing to be performed on the received data.

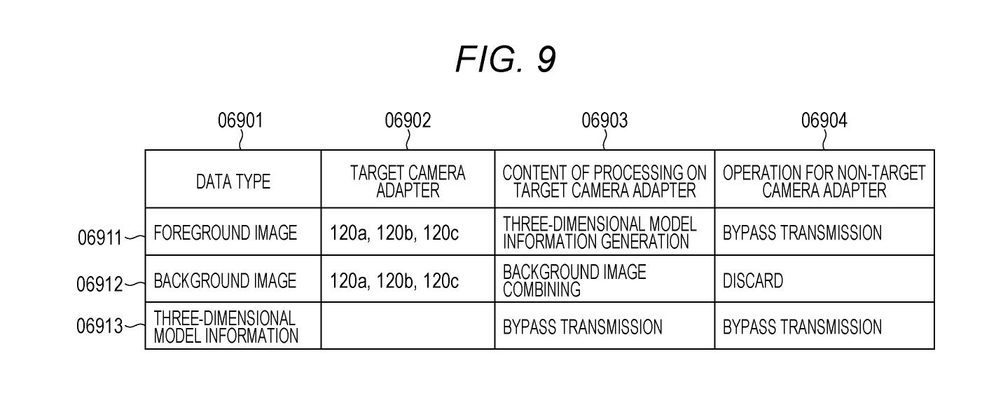

Determination of the received data processing method will be described with reference to FIG. 9. FIG. 9 illustrates a table for the camera adapter 120 to determine processing to be performed on the received data and the table is held in the camera adapter 120.

In FIG. 9, a data type 06901 indicates the data type of received data. A target camera adapter 06902 indicates a data transmission source which executes processing of a processing content 06903. The processing content 06903 indicates processing to be executed on data received from the target camera adapter 06902. An operation 06904 indicates an operation to be executed on the received data from a camera adapter other than the target camera adapter 06902. The information is not limited to these contents, but instead other information may be included.

The data type 06901 indicates the type of data received by the camera adapter 120, such as a foreground image 06911, a background image 06912, and three-dimensional data information 06913. The data type 06901 is not limited to the type of data illustrated in FIG. 9. The identifier of the camera adapter 120 which has generated data is set in the target camera adapter 06902. In step S808 of determining whether to performing image processing, output data generated by the camera adapters registered in the target camera adapter 06902 is an image processing target on which processing set in the processing content 06903 for the target camera adapter is performed. Data received from the camera adapters 120 indicated by the target camera adapter 06902 is an image processing target. Data generated by camera adapters which are not registered in the target camera adapter 06902 is not an image processing target. Processing to be performed on the data generated by camera adapters which are not registered in the target camera adapter 06902 is indicated by the operation 06904. When data generated by all camera adapters is set for the processing content 06903, a wild card may be set to the target camera adapter 06902 instead of the identifier of the camera adapter 120. Output data from all camera adapters 120 is not a processing target, nothing is set.

A content of processing to be performed on received data is registered in the processing content 06903. FIG. 9 illustrates the generation of three-dimensional model information when the received data is a foreground image and is received from the camera adapter 120a, 120b, or 120c. Processing associated with the processing described above, such as calibration, may be performed. When the received data is a foreground image and is received from a device other than the camera adapter 120a, 120b, or 120c, the processing content 06903 indicates the bypass transmission. In this case, the bypass transmission control may be performed by setting the processing counter 07101 to “0” in the bypass transmission. For example, the subsequent-stage camera adapter 120 has low correlation between images. For example, when it is difficult to generate three-dimensional model information, the subsequent-stage camera adapter 120 sets the processing counter to “0” and transmits the data.

When the received data is a background image and is received from the camera adapter 120a, 120b, or 120c, the processing content 06903 indicates processing for combining the background image. When the received data is a background image and is received from a device different from the camera adapter 120a, 120b, or 120c, the processing content 06903 indicates discarding of the received data. When the received data is three-dimensional model information, the processing content 06903 indicates the bypass transmission.

Further, when processing of the processing content 06903 is performed on the data received from the target camera adapter, updated data obtained after decrementing the processing counter 07101 is transmitted to the next camera adapter 120. In the operation 06904 to be performed on data from a non-target camera adapter, an operation to be performed when no processing is performed on the received output data is registered.

In the present exemplary embodiment, the camera adapters 120 are physically connected in cascade by a daisy chain. However, when the camera adapters 120 are logically connected in cascade, information about the camera adapter 120 of the transfer destination may be included. If the information about the camera adapter 120 of the transfer destination is set in the network adapter 06110, the information about the camera adapter 120 of the transfer destination may not be included.

The camera adapter 120 identifies processing corresponding to additional information about the received data by referring to the table illustrated in FIG. 9. When the processing corresponding to the reference data type is not set, the data may be transferred to the adjacent camera adapter 120 without performing processing to be described below on the data (S811). If it is determined that processing is performed in the determination as to whether to perform image processing (S808), the camera adapter 120 performs image processing using the received data (S809). When image processing is performed, the processing counter for the received data is decremented (S810), and the received data is transmitted to the adjacent camera adapter 120 (S811). Specifically, information indicating that image processing has been executed and/or information indicating that image processing is not necessary is added to the data subjected to the image processing.

On the other hand, if it is determined that image processing is not performed in the determination for determining whether to perform image processing (S808), the processing to be performed on the received data is determined (S812). As a result of determination in step 3812, the camera adapter 120 discards the received output data when there the data need not be transferred (S813). As a result of determination in step S812, for example, when the correlation between images is low and it is difficult to generate three-dimensional model information, the subsequent-stage camera adapter 120 controls the bypass transmission. In this case, the value of the processing counter for the received output data is updated to “0” (S814). The camera adapter 120 transfers the data obtained by updating the processing counter to the adjacent camera adapter 120 (S811). When the subsequent-stage camera adapter 120 performs processing to thereby execute appropriate image processing, the data may be transmitted to the adjacent camera adapter 120 while maintaining the value “1” of the processing counter.

The value of the processing counter may be updated to a value other than “0”. For example, when the value of the processing counter is a value less than “0”, the front-end server 230 which has received output data may perform image processing instead of the camera adapter 120. Although the processing is sequentially carried out in the present exemplary embodiment, the image processing (S809) and processing (S811) of transmitting data to the next camera adapter 120 may be carried out in parallel.

In this manner, with reference to the header portion 07201 of the received foreground image, processing is determined by, for example, determining whether the received foreground image is output to the image processing unit 06130, or determining whether the received foreground image is transferred to the next camera adapter 120. In addition, the header portion 07201 of the received foreground image is updated, thereby enabling the next camera adapter 120 and subsequent camera adapters 120 to instruct processing to be performed on the received foreground image. Accordingly, when a certain camera adapter 120 transmits a foreground image by bypass transmission, the header portion 07201 of the foreground image is not updated, so that the camera adapter 120 which has subsequently received data can perform the processing to be performed by the bypassed camera adapter 120. The camera adapter 120 which transfers the foreground image can instruct the processing without determining whether the state of the camera adapter 120 of the transfer destination is a bypass state.

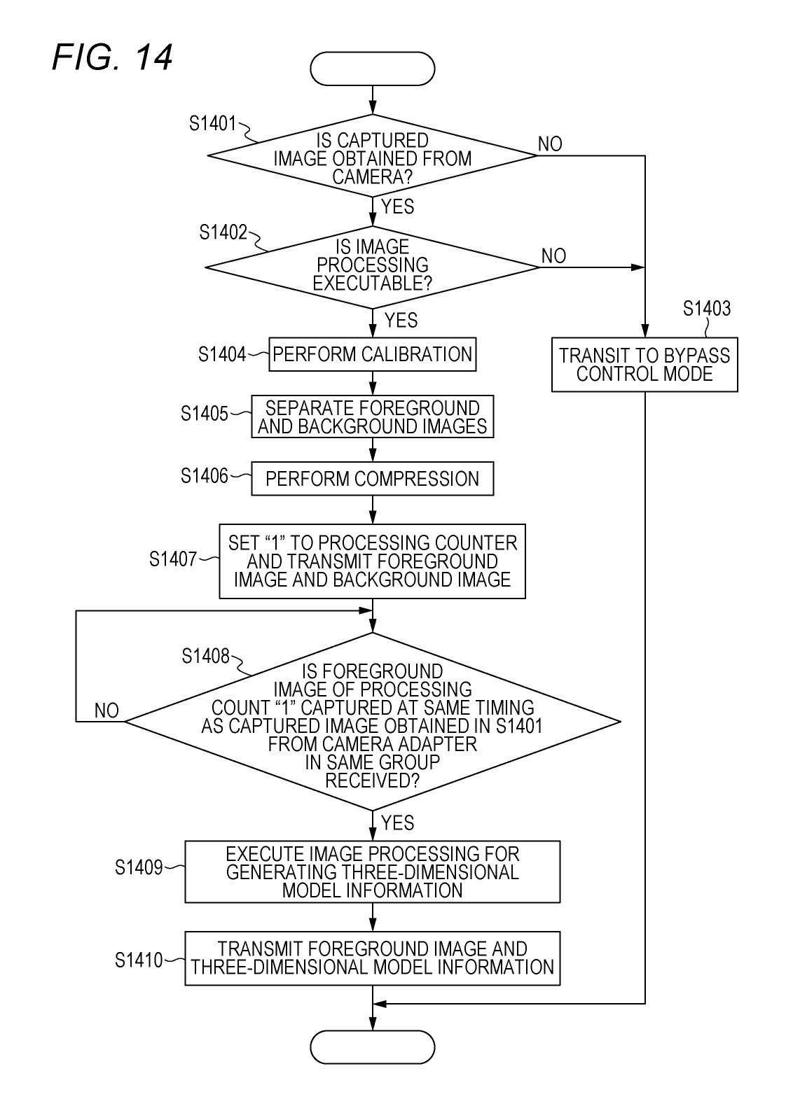

Next, an operation to be performed when a captured image is acquired from the camera 112 connected to the camera adapter 120 will be described with reference to a flowchart of FIG. 14. The flowchart illustrated in FIG. 14 is implemented in such a manner that the processor 1201 of the camera adapter 120 executes operation and processing of information and control of each piece of hardware. Some or all of the steps of the flowchart illustrated in FIG. 14 may be implemented by hardware such as an FPGA or an ASIC.

The camera adapter 120 determines whether a captured image is received from the connected camera 112 at a predetermined timing (S1401). The predetermined timing may be, for example, a timing between the execution of image capturing by the camera 112 and the execution of subsequent image capturing. Specifically, the camera adapter 120 determines whether the captured image has been acquired after the execution of image capturing by the camera 112 and during a period determined based on an image capturing frame rate of the camera 112. In step S1401, if it is determined that the captured image is received from the camera 112 at a predetermined timing, the processing proceeds to step S1402. On the other hand, if it is determined that the captured image is not received from the camera 112 at the predetermined timing, the processing proceeds to step S1403. The determination in step S1401 may be a determination as to whether a notification indicating a power OFF state or a failure state is received from the camera 112. In this case, if the camera adapter 120 has received the notification indicating the power OFF state or the failure state from the camera 112, the processing proceeds to step S1403. If the camera adapter 120 has not received the notification indicating the power OFF state or the failure state from the camera 112, the processing proceeds to step S1402.

In step S1401, if the captured image is captured from the camera 112, the camera adapter 120 determines whether to execute image processing on the acquired captured image (S1402). The determination in step S1402 may be a determination as to whether the image processing unit 06130 of the camera adapter 120 is operable. When the image processing unit 06130 is not operable due to a failure or the like, the camera adapter 120 determines that image processing cannot be executed on the acquired captured image. The determination in step S1402 may be made based on the acquired captured image. In a case where the captured image is not appropriate as a captured image used for a virtual viewpoint image, for example, because an obstacle (such as reflection of an audience) in the acquired image, it is determined that image processing cannot be executed on the acquired captured image. It is determined that image processing cannot be executed on the acquired captured image when the captured image is not appropriate as a captured image used for a virtual viewpoint image, for example, when the imaging range is changed due to a movement or trick of the camera 112 caused by a vibration. In step S1402, if it is determined that image processing cannot be executed on the acquired captured image, the processing proceeds to step S1403. In step S1403, the camera adapter 120 transits to the bypass control mode (S1403).

In step S1402, if it is determined that image processing can be executed on the acquired captured image, the camera adapter 120 performs processing, such as calibration, foreground/background separation, and compression, on the acquired captured image (S1404 to S1406). The camera adapter 120 adds, to the compressed foreground image, additional information obtained by setting “1” to the processing counter as information which indicates that image processing is performed and is indicated by other camera adapters 120 at the subsequent stage, and transmits the foreground image to the adjacent camera adapter 120 (S1407). Further, the camera adapter 120 transmits the background image to the adjacent camera adapter 120 (S1407).

The camera adapter 120 determines whether the foreground image of the processing count “1”, which is captured at the same timing as the captured image acquired in step S1401 from the camera adapter belonging to the same gazing point group, has been received (S1408). If the camera adapter 120 determines that the foreground image has been received in step S1408, the camera adapter 120 executes image processing for generating three-dimensional model information using the received foreground image and the foreground image separated in step S1405 (S1409). The camera adapter 120 sets the value of the processing counter for the foreground image received in step S1408 to “0” and transmits the foreground image to the other adjacent camera adapter 120. Further, the camera adapter 120 transmits the three-dimensional model information generated in step S1409 to the other adjacent camera adapter 120 (S1410).

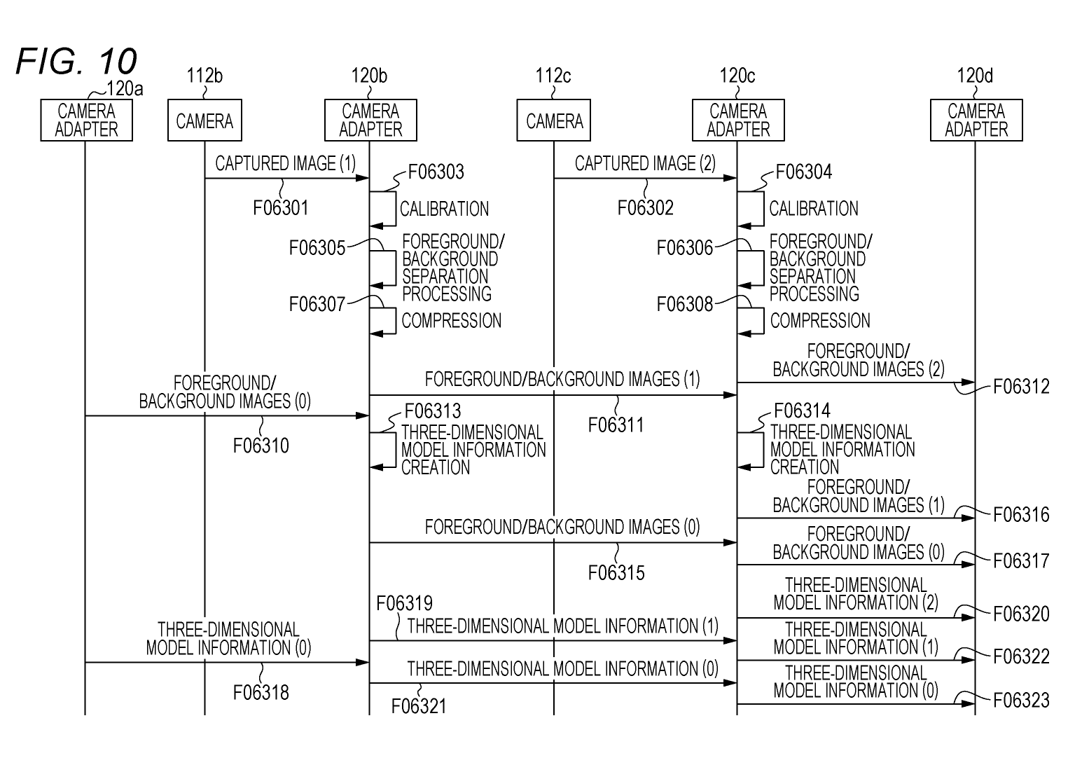

Next, a processing sequence for generating three-dimensional model information by a plurality of camera adapters 120 (120a, 120b, 120c, and 120d) in cooperation with each other according to the present exemplary embodiment will be described with reference to FIG. 10. The processing order is not limited to that illustrated in FIG. 10.

The image processing system 100 of the present exemplary embodiment includes 26 cameras 112 and 26 camera adapters 120. However, only the two cameras 112b and 112c and the four camera adapters 120a to 120d are focused on in the present exemplary embodiment. The camera 112b is connected to the camera adapter 120b, and the camera 112c is connected to the camera adapter 120c. The camera 112 connected to the camera adapter 120a, the camera 112 connected to the camera adapter 120d, and the microphones 111, the pan heads 113, and the external sensors 114 which are connected to the respective camera adapters 120 are omitted for ease of explanation. Further, it is assumed that the camera adapters 120a to 120d have completed the time synchronization with the time server 290 and are in the imaging state. It is also assumed that the camera adapters 120a, 120b, 120c, and 120d belong to the same gazing point group A.

In FIG. 10, the cameras 112b and 112c transmit captured images (1) and (2), which are captured at the same time by being synchronized, to the camera adapters 120b and 120c, respectively (F06301 and F06302). The camera adapters 120b and 120c cause the calibration control unit 06133 to perform calibration processing on the received captured images (1) and (2), respectively (F06303 and F06304). Examples of the calibration processing include color correction and blur correction. Although the calibration processing is performed in the present exemplary embodiment, the calibration process need not necessarily be performed.

Next, the camera adapters 120b and 120c cause the foreground/background separation unit 06131 to perform foreground/background separation processing on the captured image (1) or (2) which has been subjected to the calibration processing (F06305 and F06306). The camera adapters 120b and 120c cause the data compression/expansion unit 06121 to perform compression of a data amount on each of the foreground image and the background image which are separated from each other (F06307, F06308). The compression rate may be changed in accordance with the degree of importance of each of the foreground image and the background image which are separated from each other. For example, the camera adapter 120 may compress at least the background image out of the foreground image and the background image so that the compression rate of the foreground image is lower than that of the background image, and may output the compressed background image to the next camera adapter 120. The foreground image including an important imaging target may be subjected to lossless compression and the background image may be subjected to compression with a loss. Further, the foreground image including no important imaging target may be subjected to compression with a loss. Accordingly, the amount of data to be subsequently transmitted to the next camera adapter 120c or the next camera adapter 120d can be efficiently reduced. For example, in a case where an image of a field of a stadium where a game of soccer, rugby, baseball, or the like is held is captured, a background image occupies most of the image and the area of a foreground image including players is small. Therefore, the amount of transmission data can be considerably reduced. In the present exemplary embodiment, the camera adapter 120 is configured to perform compression processing for compressing the amount of data on the data to be transmitted, but the compression processing need not necessarily be performed.

Further, the camera adapter 120 may change a frame rate of an image to be output to the next camera adapter 120 in accordance with the degree of importance. For example, the foreground image including the important imaging target may be output with a high frame rate so that the output frame rate of the background image is lower than that of the foreground image, and the background image which does not include the imaging target may be output with a low frame rate. Accordingly, the amount of data to be transmitted to the next camera adapter 120c or the next camera adapter 120d can be reduced. The compression rate or the transmission frame rate may be changed for each camera adapter 120 in accordance with an installation place of the camera 112, an imaging place, and/or the performance of the camera 112. Further, a three-dimensional structure of seats or the like of the stadium may be checked in advance using drawings, and therefore, the camera adapter 120 may transmit an image obtained by removing a portion corresponding to the seats from the background image. Thus, at the time of rendering, image rendering is performed while players in a game are focused on by using the stadium three-dimensional structure generated in advance so that the effect that the amount of data to be transmitted and stored in the entire system can be reduced is attained.

Next, the camera adapters 120 transmit the compressed foreground images and the compressed background images to the adjacent camera adapters 120 (F06310, F06311, and F06312). Further, the camera adapter 120 adds information indicating that image processing is required to the compressed foreground image and transmits the information. Specifically, the camera adapter 120 sets “1” to the processing count and transmits the foreground image. Although the foreground image and the background image are simultaneously transferred in the present exemplary embodiment, the foreground image and the background image may be individually transferred.

Next, the camera adapter 120b generates three-dimensional model information using the foreground image received from the camera adapter 120a and the foreground image separated by the foreground/background separation processing F06305 (F06313). Similarly, the camera adapter 120c creates three-dimensional model information (F06314).

Next, the camera adapter 120b transfers the foreground image and background image received from the camera adapter 120a to the camera adapter 120c (F06315). Further, the camera adapter 120b deletes information indicating that image processing is required for the foreground image which has been received from the camera adapter 120a and has been subjected to image processing, and then transmits the received foreground image to the subsequent stage. Specifically, the camera adapter 120b sets “0” to the processing count and transmits the foreground image received from the camera adapter 120a to the camera adapter 120c. The camera adapter 120b may add information indicating that image processing is not required to the foreground image which has been received from the camera adapter 120a and has been subjected to image processing, and may transmit the foreground image to the camera adapter 120c. Similarly, the camera adapter 120c transfers the foreground image and the background image to the camera adapter 120d. Although the foreground image and the background image are simultaneously transferred in the present exemplary embodiment, the foreground image and the background image may be individually transferred.

Further, the camera adapter 120c transfers the foreground image and background image, which have been created by the camera adapter 120a and have been received from the camera adapter 120b, to the camera adapter 120d (F06317). Since the processing counter added to the foreground image which has been created by the camera adapter 120a and has been received from the camera adapter 120b is “0”, the camera adapter 120c does not generate three-dimensional model information using the foreground image.

Next, the camera adapters 120a to 120c transfer the created three-dimensional model information to the next camera adapters 120b to 120d, respectively (F06318, F06319, F06320).

Further, the camera adapters 120b and 120c sequentially transfer the received three-dimensional model information to the next camera adapters 120c and 120d (F06321, F06322). Furthermore, the camera adapter 120c transfers, to the camera adapter 120d, the three-dimensional model information which has been created by the camera adapter 120a and has been received from the camera adapter 120b (F06323).

Lastly, the foreground image, the background image, and the three-dimensional model information which are created by the camera adapters 120a to 120d are sequentially transmitted to the camera adapters 120, which are connected via a network, and are then transmitted to the front-end server 230.

In the sequence diagram, descriptions of calibration processing, foreground/background separation processing, compression processing, and three-dimensional model information creation processing of the camera adapter 120a and the camera adapter 120d are omitted. However, in practice, the camera adapter 120a and the camera adapter 120d also perform processing similar to that performed in the camera adapter 120b and the camera adapter 120c, and create the foreground image, the background image, and the three-dimensional model information. Although the sequence of data transfer among the four camera adapters 120 is described in the present exemplary embodiment, similar processing is performed also when the number of camera adapters 120 is increased.

As described above, the camera adapter 120 other than the last camera adapter 120 in a predetermined order of a plurality of camera adapters 120 extracts a predetermined area from an image captured by the corresponding camera 112. Then, the camera adapter 120 outputs image data based on the extraction result to the next camera adapter 120 in the predetermined order. On the other hand, the last camera adapter 120 in the predetermined order outputs the image data based on the extraction result to the front-end server 230. Specifically, a plurality of camera adapters 120 is connected by a daisy chain and image data based on the result of extracting the predetermined area from the captured image by each camera adapter 120 is input to the front-end server 230 by the predetermined camera adapter 120. The use of such a data transmission method prevents a fluctuation in processing load or network transmission load in the front-end server 230 when the number of sensor systems 110 in the image processing system 100 varies. The image data output from the camera adapter 120 may be data generated using the image data based on the extraction result and the image data based on the result of extraction of the predetermined area by the previous camera adapter 120 in the predetermined order. For example, image data based on a difference between the extraction result of each camera adapter 120 and the extraction result of the previous camera adapter 120 is output to thereby reduce the amount of transmission data in the system. The last camera adapter 120 in the order described above receives, from the other camera adapters 120 described above, extracted image data based on the image data on the predetermined area extracted from images captured by the other cameras 112 by the other camera adapters 120. Then, the image data based on the extraction result of the predetermined area extracted by the camera adapter 120 itself and the extracted image data received from the other camera adapters 120 is output to the image computing server 200 for generating a virtual viewpoint image.

Further, the camera adapter 120 divides the image captured by each camera 112 into a foreground portion and a background portion, and changes the compression rate or the transmission frame rate, for example, in accordance with the degree of importance of each portion. Thus, the amount of data to be transmitted can be reduced as compared with a case where all data obtained by the cameras 112 are transmitted to the front-end server 230. Three-dimensional model information required for generating a three-dimensional model is sequentially created by each camera adapter 120. Consequently, the processing load of the server can be reduced and three-dimensional model can be generated in more real time as compared with a case where all data is collected in the front-end server 230 and three-dimensional model generation processing is performed on all data in the server.

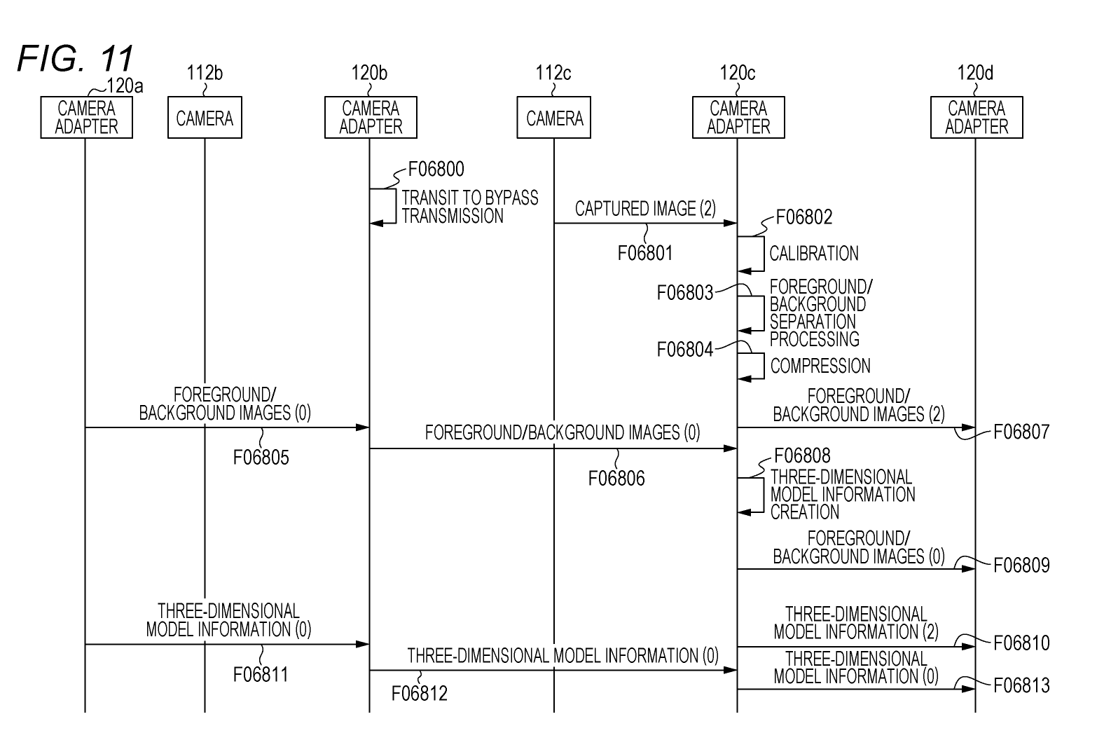

Next, a sequence of processing of generating three-dimensional model information by coordinating the plurality of camera adapters 120 (120a, 120b, 120c, and 120d) with one another when the camera adapter 120b according to the present exemplary embodiment is in the bypass control mode will be described with reference to FIG. 11. The processing order is not limited to that illustrated in FIG. 11.

The image processing system 100 of the present exemplary embodiment includes 26 cameras 112 and 26 camera adapters 120. However, only the two cameras 112b and 112c and the four camera adapters 120a to 120d are focused on in the present exemplary embodiment. The camera 112b is connected to the camera adapter 120b, and the camera 112c is connected to the camera adapter 120c. The camera 112 connected to the camera adapter 120a, the camera 112 connected to the camera adapter 120d, and the microphones 111, the pan heads 113, and the external sensors 114 which are connected to the respective camera adapters 120 are omitted. Further, it is assumed that the camera adapters 120a to 120d have completed the time synchronization with the time server 290 and are in the imaging state. It is also assumed that the camera adapters 120a, 120b, 120c, and 120d belong to the same gazing point group A.

Upon detecting, for example, a failure state or a power OFF state of the camera 112b, the camera adapter 120b transits to the bypass control mode (F06800). When the camera adapter 120b does not receive the captured image from the camera 112b within a predetermined period from the imaging timing, the camera adapter 120b may transit to the bypass control mode. In FIG. 11, unlike in FIG. 10, the camera adapter 120b cannot acquire the captured image (1) due to a failure of the camera 112b. The camera adapter 120c receives the captured image (2) from the camera 112c (F06801) and performs calibration (F06802), foreground/background separation processing (F06803), and compression (F06804) on the captured image (2). These processing are similar to the processing F06302, F06304, F06306, and F06308, and thus descriptions thereof are omitted.

Like in F06310, the camera adapter 120a transfers a compressed foreground image (0) and a background image to the adjacent camera adapter 120b (F06805). The camera adapter 120a adds information indicating that image processing is required to the compressed foreground image (0) and transmits the foreground image (0). Specifically, the camera adapter 120a sets “1” to the processing count and transmits the foreground image (0) to the camera adapter 120b. Although the foreground image and the background image are simultaneously transferred in the present exemplary embodiment, the foreground image and the background image may be individually transferred. Next, since the camera adapter 120b is in the bypass control mode, the network adapter 06110 transmits the foreground image (0) to the camera adapter 120c by bypass transmission without performing image processing on the foreground image (0) received from the camera adapter 120a (F06806).

In this case, the camera adapter 120b does not decrement the processing counter for the received foreground image (0), thereby informing the subsequent-stage camera adapter of the necessity of image processing. Further, the camera adapter 120b in the bypass control mode may add information indicating that image processing is required to the foreground image (0) received from the camera adapter 120a and may transmit the foreground image (0).

The camera adapter 120c detects that information indicating that image processing is required is added to the foreground image (0) received from the camera adapter 120b in F06806. Accordingly, the camera adapter 120c creates three-dimensional model information using the foreground image (0) received in F06806 and the foreground (2) separated in the foreground/background separation processing F06803 (F06808). The camera adapter 120c may determine whether the foreground image of the image captured by the camera 112b can be received within a predetermined period from the imaging timing. If the foreground image cannot be received within the predetermined period, the camera adapter 120c may determine that three-dimensional model information is generated using the foreground image (2) and the foreground image generated in the device located ahead of the camera adapter 120b in the daisy chain.

Further, the camera adapter 120c transfers, to the camera adapter 120d, the foreground image (0), the background image (0), and three-dimensional model information (2) created in F06808 (F06809, F06810). The camera adapter 120c deletes information indicating that image processing is required for the foreground image (0) subjected to the image processing in F06808 and transmits the foreground image (0) to the subsequent-stage camera adapter 120d. Specifically, the camera adapter 120c sets the processing count to “0” and transmits the foreground image (0) to the camera adapter 120d. The camera adapter 120c may add information indicating that image processing is not required to the foreground image (0) which has been subjected to the image processing and may transmit the foreground image (0) to the camera adapter 120c.

Next, the camera adapter 120a transfers the three-dimensional model information (0) to the adjacent camera adapter 120b (F06811). Similarly, the camera adapter 120b causes the network adapter 06110 to transmit the three-dimensional model information (0) received from the camera adapter 120a to the camera adapter 120c by bypass transmission (F06812). Further, the camera adapter 120c transmits the three-dimensional model information (0) received from the camera adapter 120b to the camera adapter 120d by bypass transmission (F06813).

Lastly, the foreground images, the background images, and the three-dimensional model information which are created by the camera adapters 120a to 120d are sequentially transmitted to the camera adapters 120 which are connected via a network, and are then transmitted to the front-end server 230. Thus, according to the image processing system 100 of the present exemplary embodiment, even when the camera 112b cannot capture images and thus the camera adapter 120b cannot generate three-dimensional model information, another apparatus can generate three-dimensional model information instead of the camera adapter 120b. Accordingly, the possibility that a virtual viewpoint image may be impaired, the image quality may be lowered, or it may take a lot of time to generate a virtual viewpoint image can be reduced. Therefore, according to the present exemplary embodiment, in a case where image processing is performed by a plurality of apparatuses, even if some of the apparatuses cannot execute the processing, adverse effects thereof can be reduced.

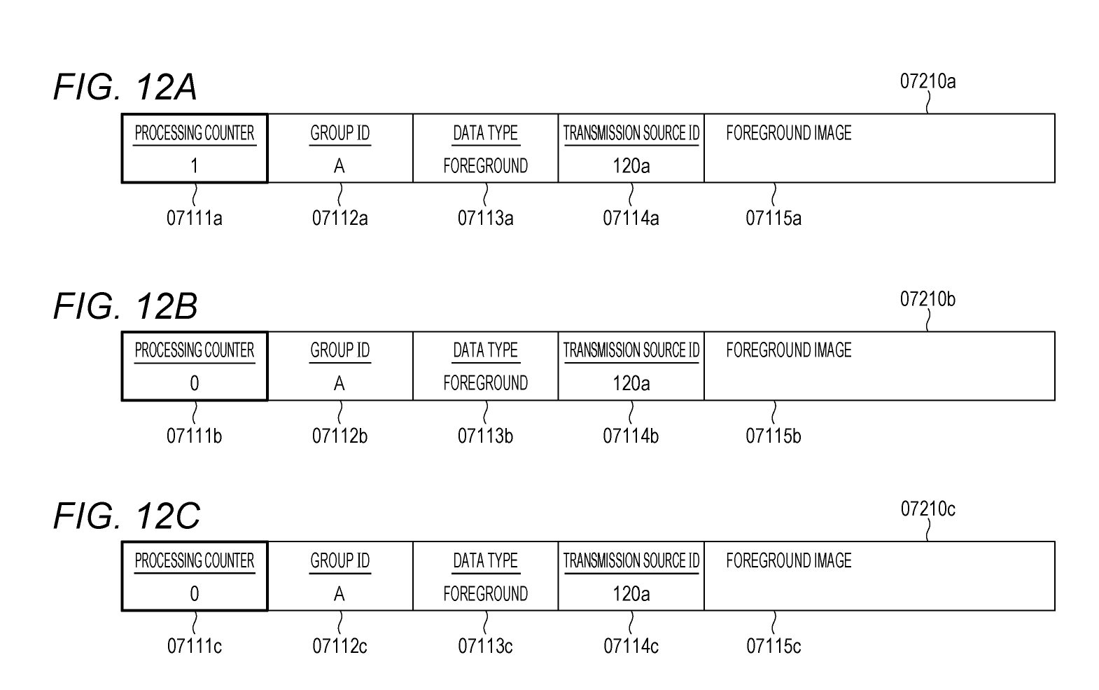

Next, an operation to be performed on output data (F06310, F06315, F06317) when the foreground/background image (0) illustrated in FIG. 10 is transmitted will be described with reference to FIGS. 12A to 12C. Although only the foreground image will be described with reference to FIGS. 12A to 12C, the same holds true for the background image.

Output data 07210a from the camera adapter 120a is output data to be transmitted to the camera adapter 120b by the camera adapter 120a. The output data 07210a of the camera adapter 120a includes a header and a payload as additional information. As the additional information, the value of the processing counter which is registered in advance for each data type in the camera adapter 120a is set to a processing counter 07111a. The value of the processing counter indicates the number of times of image processing to be performed on the output data by the other camera adapters 120. FIG. 12A illustrates that the foreground image is used only once in the image processing of the other camera adapters 120. In the case of performing image processing a plurality of times, a value equal to or greater than “2” may be set to the processing counter. The output data 07210a includes a group ID 07112a for identifying the gazing point group to which the camera adapter 120a belongs, and a data type 07113a of output data. The output data 07210a also includes a transmission source ID 07114a for identifying the camera adapter 120a and a foreground image 07115a which is stored in a payload portion.

Next, the camera adapter 120b which has received the output data 07210a analyzes the header portion, which is additional information about output data 07110a, and determines whether to execute image processing. The value of the processing counter 07111a of the camera adapter 120b is equal to or greater than “1” and the camera adapter 120b has the same group ID 07112b, and thus the camera adapter 120b determines to execute image processing. Further, the camera adapter 120b identifies processing to be executed on the data type 07113a and the transmission source ID 07114a. In this case, the camera adapter 120b generates three-dimensional model information. The camera adapter 120b decrements the value of the processing counter after execution of the processing, to thereby update a processing counter 07111b. The camera adapter 120b transmits the received foreground image to the next camera adapter 120c as output data without updating the other header information. FIG. 12B illustrates additional information about output data 07210b transmitted from the camera adapter 120b in this case.

Next, the camera adapter 120c which has received the output data 07210b does not analyze the output data 07210b, does not determine whether to execute image processing, and does not execute image processing. In other words, since the value of the processing counter 07111b is less than “1”, the camera adapter 120c does not perform image processing. Accordingly, the camera adapter 120c does not change the additional information and transmits output data 07210c illustrated in FIG. 12C to the camera adapter 120d.

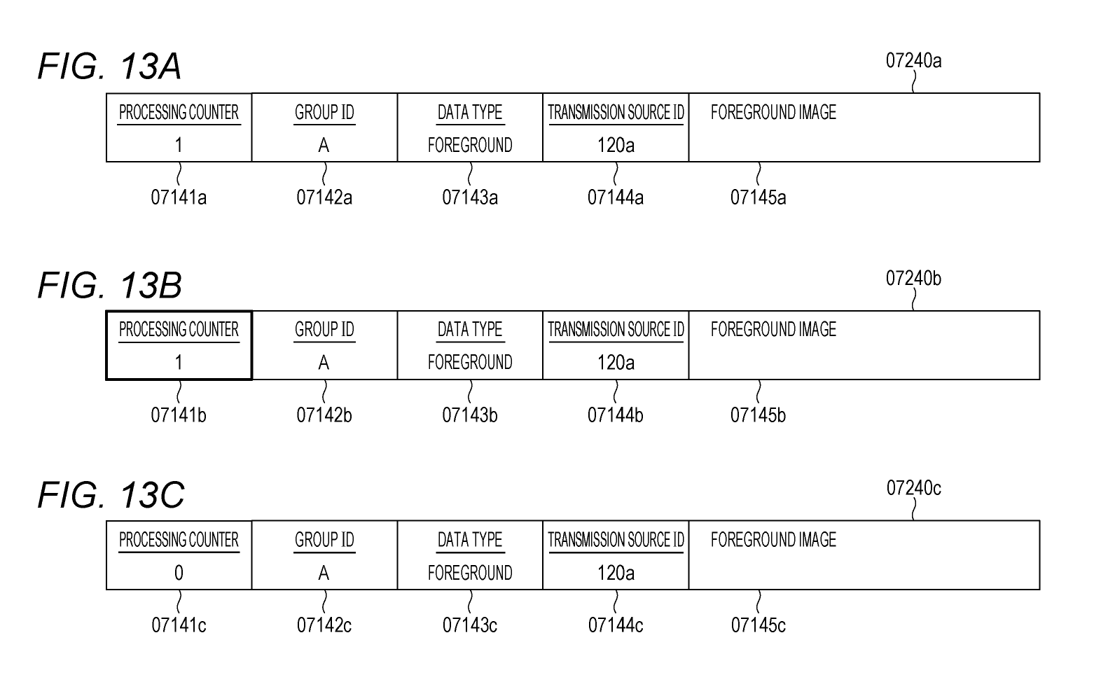

Next, an operation to be performed on output data (F06805, F06806, F06809) when the foreground/background image (0) illustrated in FIG. 11 is transmitted will be described with reference to FIGS. 13A to 13C. Although only the foreground image will be described with reference to FIGS. 13A to 13C, the same holds true for the background image.

Output data 07240a from the camera adapter 120a is similar to the output data 07210a illustrated in FIG. 12A. Next, output data 07240b transmitted from the camera adapter 120b is identical to the output data 07240a, not changed from the output data 07240a, because the camera adapter 120b is in the bypass control mode.

Next, the camera adapter 120c which has received the output data 07240b analyzes the additional information about the output data 07240b, determines whether to execute image processing, and executes image processing. In other words, the camera adapter 120c performs the processing to be performed by the camera adapter 120b. Accordingly, the camera adapter 120c transmits output data 07240c for which the processing counter is set to “0” to the camera adapter 120d.

As described above, the camera adapter 120a can create output data regardless of whether the camera adapter 120b is in the bypass state, and can request the subsequent-stage camera adapter 120b or 120c to perform processing on the output data. Consequently, retransmission and the like of the output data from the camera adapter 120a and be performed in real time without a delay.

According to the image processing system 100 of the present exemplary embodiment, even when the camera 112b cannot capture images and thus the camera adapter 120b cannot generate three-dimensional model information, another apparatus can generate three-dimensional model information instead of the camera adapter 120b. Accordingly, the possibility that a virtual viewpoint image may be impaired, the image quality may be lowered, or it may take a lot of time to generate a virtual viewpoint image can be reduced. Therefore, according to the present exemplary embodiment, in a case where image processing is performed by a plurality of apparatuses, even if some of the apparatuses cannot execute the processing, adverse effects thereof can be reduced. Furthermore, according to the present exemplary embodiment, an image processing apparatus can determine whether to execute image processing on images transmitted in a system in which a plurality of images is processed by a plurality of image processing apparatuses. Moreover, according to the present exemplary embodiment, the cooperation among the plurality of image processing apparatuses to perform image processing can be appropriately implemented and the possibility that image processing for a virtual viewpoint content may not be fully executed on images can be reduced.

### Other Exemplary Embodiments

The exemplary embodiments described above illustrate an example in which a foreground image is transmitted among the camera adapters 120 as a result of extracting a predetermined object. However, the captured image itself may be transmitted, or images subjected to other processing may be transmitted among the camera adapters 120. The above exemplary embodiments also illustrate an example in which it is determined whether to execute image processing for generating three-dimensional model information using additional information about images transmitted among the camera adapters 120. However, the image processing is not limited to image processing for generating three-dimensional model information. It may be determined whether to execute other image processing for generating a virtual viewpoint content using additional information about images transmitted among the camera adapters 120. Alternatively, the content of image processing for generating a virtual viewpoint content may be determined using additional information about images transmitted among the camera adapters 120. More alternatively, it may be determined whether to execute image processing for generating three-dimensional model information or execute other image processing by using additional information about images transmitted among the camera adapters 120.

According to the exemplary embodiments described above, an image processing apparatus can determine whether to execute image processing on images transmitted in a system in which a plurality of images is processed by a plurality of image processing apparatuses.

The present disclosure can also be implemented by processing in which a program for implementing one more functions of the exemplary embodiments described above is supplied to a system or an apparatus via a network or storage media, and one or more processors in a computer of the system or the apparatus loads a program and executes the loaded program. The present disclosure can also be implemented by a circuit (e.g., an ASIC) that implements one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-121703, filed Jun. 21, 2017, which is hereby incorporated by reference herein in its entirety.

What is claimed is:

1. An image processing apparatus comprising:
a first acquisition unit configured to acquire, from a first another image processing apparatus, an image based on image capturing by a first imaging apparatus and additional information about the image;
a second acquisition unit configured to acquire an image captured by a second imaging apparatus different from the first imaging apparatus;
a determination unit configured to determine whether to execute predetermined image processing for generating a virtual viewpoint image, by using the image acquired by the first acquisition unit and the image acquired by the second acquisition unit based on the additional information acquired by the first acquisition unit; and
a processing unit configured to execute the predetermined image processing in a case where the determination unit determines that the predetermined image processing is executed.

2. The image processing apparatus according to claim 1, further comprising a transmission unit configured to transmit, to a second another image processing apparatus, the image acquired by the first acquisition unit and additional information for causing the second another image processing apparatus to execute image processing by using the image acquired by the first acquisition unit.

3. The image processing apparatus according to claim 2, wherein the transmission unit transmits, to the second another image processing apparatus, the image acquired by the first acquisition unit and additional information for the second another image processing apparatus to determine whether to execute the predetermined image processing using at least the image acquired by the first acquisition unit.

4. The image processing apparatus according to claim 2, wherein the transmission unit further transmits, to the second another image processing apparatus, the image acquired by the second acquisition unit and additional information for causing the second another image processing apparatus to execute image processing using the image acquired by the second acquisition unit.

5. The image processing apparatus according to claim 2, wherein when the determination unit determines to execute the predetermined image processing, the transmission unit transmits, to the second another image processing apparatus, additional information for causing the second another image processing apparatus not to execute image processing by using the image acquired by the first acquisition unit.

6. The image processing apparatus according to claim 2, wherein when the determination unit determines to not execute the predetermined image processing, the transmission unit transmits, to the second another image processing apparatus, additional information for causing the second another image processing apparatus not to execute image processing by using the image acquired by the first acquisition unit.

7. The image processing apparatus according to claim 2, wherein the transmission unit transmits, to the second another image processing apparatus, additional information for causing the second another image processing apparatus to determine a content of image processing to be executed.

8. The image processing apparatus according to claim 2, wherein the transmission unit transmits, to the second another image processing apparatus, additional information for causing the second another image processing apparatus to determine whether to execute image processing.

9. The image processing apparatus according to claim 1, wherein when the additional information includes information indicating that the predetermined image processing is required, the determination unit determines that the predetermined image processing is executed.

10. The image processing apparatus according to claim 1, wherein when the additional information includes information indicating a group for processing an image obtained by capturing an image of an area common to the image processing apparatus, the determination unit determines that the predetermined image processing is executed.

11. The image processing apparatus according to claim 1, wherein the image processing apparatus is connected to the first another image processing apparatus by a daisy chain.

12. The image processing apparatus according to claim 1, wherein
when the first another image processing apparatus executes image processing to be executed using the image acquired by the first imaging apparatus, the acquisition unit acquires additional information indicating that the image processing is executed,
when the first other image processing apparatus does not execute image processing to be executed using the image captured by the first imaging apparatus, the acquisition unit acquires additional information indicating that the image processing is not executed,
when the first another image processing apparatus executes image processing to be executed using the image captured by the first imaging apparatus, the determination unit determines that the predetermined image processing is not executed using the image acquired by the first acquisition unit and the image acquired by the second acquisition unit is not executed, and
when the first other image processing apparatus does not execute image processing to be executed using the image captured by the first imaging apparatus, the determination unit determines that the predetermined image processing is executed using the image acquired by the first acquisition unit and the image acquired by the second acquisition unit.

13. The image processing apparatus according to claim 1, wherein when the second acquisition unit cannot acquire the image captured by the second imaging apparatus, the determination unit determines that the predetermined image processing is not executed using the image acquired by the first acquisition unit, regardless of the additional information about the image acquired by the first acquisition unit.

14. The image processing apparatus according to claim 1, wherein the processing unit generates three-dimensional model information by executing the predetermined image processing.

15. The image processing apparatus according to claim 1, wherein the first acquisition unit acquires an image indicating a result of extracting a predetermined object included in a captured image.

16. The image processing apparatus according to claim 1, wherein the processing unit generates an image indicating a result of extracting a predetermined object included in the image acquired by the second acquisition unit, and execute the predetermined image processing using the generated image and the image acquired by the first acquisition unit.

17. An image processing system comprising:
a plurality of image processing apparatuses that processes a plurality of images captured by a plurality of imaging apparatuses,
a first acquisition unit configured to acquire, from a first image processing apparatus in the plurality of image processing apparatuses, an image based on image capturing by a first imaging apparatus in the plurality of imaging apparatuses and additional information about the image;
a second acquisition unit configured to acquire an image captured by a second imaging apparatus, different from the first imaging apparatus, in the plurality of imaging apparatuses;
a determination unit configured to determine whether to execute predetermined image processing for generating a virtual viewpoint image, by using the image acquired by the first acquisition unit and the image acquired by the second acquisition unit based on the additional information about the image acquired by the first acquisition unit; and
a processing unit configured to execute the predetermined image processing in a case where the determination unit determines that image processing is executed.

18. The image processing system according to claim 17, further comprising a server configured to generate the virtual viewpoint image based on a result of processing performed by the plurality of image processing apparatuses.

19. An image processing method to be performed by an image processing apparatus, comprising:
a first acquisition step of acquiring an image from a first another image processing apparatus, an image based on image capturing by a first imaging apparatus and additional information about the image being added to the image;
a second acquisition step of acquiring an image captured by a second imaging apparatus different from the first imaging apparatuses;
a determination step of determining whether to execute predetermined image processing for generating a virtual viewpoint image, by using the image acquired in the first acquisition step and the image acquired in the second acquisition step based on the additional information acquired in the first acquisition step; and
a processing step of executing the predetermined image processing in a case where it is determined that the predetermined image processing is executed in the determination step.
